(19) United States
(12) Patent Application Publication
(10) Pub. No.: US 2009/0119989 A1
(43) Pub. Date: May 14, 2009

(54) Hydrogen generator with low volume high surface area reactor

(75) Inventors: Sandra Withers-Kirby, College Station, TX (US); Jay Neutzler, Palm Beach Gardens, FL (US); Roger Van Boeyen, Bryan, TX (US); Mehmet Kesmez, College Station, TX (US); Jady Stevens, Bryan, TX (US)

Correspondence Address: FORTKORT & HOUSTON P.C., 9442 N. CAPITAL OF TEXAS HIGHWAY, ARBORETUM PLAZA ONE, SUITE 500, AUSTIN, TX, 78759, US

(73) Assignee: Lynntech, Inc.

(21) Appl. No.: 12/231,286

(22) Filed: Sep. 2, 2008

Related U.S. Application Data
(60) Provisional application No. 60/967,035, filed on Aug. 31, 2007.

(51) Int. Cl. C01B 3/02

(52) U.S. Cl. 48/61

(57) ABSTRACT

A hydrogen generator, comprising (101), comprising (a) a reaction chamber (115) equipped with a tortuous passageway (247) for the flow of reactants therethrough, said passageway containing a catalyst disposed on a surface thereof; (b) a fluid; and (c) a hydrogen-containing material (125) that reacts with said fluid in the presence of said catalyst to generate hydrogen gas.

### CROSS REFERENCE TO RELATED APPLICATION

This application claims the benefit of priority from U.S. Provisional Application No. 60/967,035, filed Aug. 31, 2007, having the same title, and having the same inventors, and which is incorporated herein by reference in its entirety.

### FIELD OF THE DISCLOSURE

The present disclosure relates generally to hydrogen generators, and more particularly to hydrogen generators having low volume, high surface area reactors.

### BACKGROUND OF THE DISCLOSURE

Hydrogen generators are devices that generate hydrogen gas for use in fuel cells, combustion engines, and other devices, often through the evolution of hydrogen gas from chemical hydrides, borohydrides or boranes. Sodium borohydride (NaBH₄) has emerged as a particularly desirable chemical hydride for use in such devices, due to the molar equivalents of hydrogen it generates (see EQUATION 1 below), the relatively low mass of NaBH₄ as compared to some competing materials, and the controllability of the hydrogen evolution reaction:

NaBH₄+2H₂O [symbol] NaBO₂+4H₂ (EQUATION 1)

The hydrolysis of hydrogen-generating materials in general, and sodium borohydride in particular, as a method of hydrogen generation has received significant interest in the art, due to the high gravimetric storage density of hydrogen in these materials and the ease of creating a pure hydrogen stream from the hydrolysis reaction. However, in some applications, such as when hydrogen generators are used in combination with hydrogen fuel cells to power laptops or handheld devices and electronics, the inability to adequately control the generation of hydrogen gas is a drawback from a system perspective. Ideally, in such an application, the hydrogen generator should be able to produce a stream of hydrogen gas promptly when the gas stream is needed, and should likewise be able to promptly terminate the flow of hydrogen gas when it is no longer needed.

In reality, however, most hydrogen generators currently available display a significant lag time from the point of time at which the demand for hydrogen commences, and the point of time at which the flow of hydrogen gas is suitable to meet that demand. Perhaps more significantly, the flow of hydrogen in most currently available hydrogen generators does not cease with demand, and may even proceed until the hydrogen generating material has been depleted. The generation of hydrogen gas in excess of demand is problematic for hydrogen generators in general, and for small hydrogen generators (of the type designed for incorporation into laptop PCs and hand-held devices) in particular. Aside from the danger of fire or explosion, the excess gas creates pressure spikes that can damage the generator and its components.

Moreover, the need to accommodate such pressure spikes and to store excess hydrogen gas requires hydrogen generators to be heavier, bulkier, stronger, and more complicated than would otherwise be the case. Since space and weight are typically at a premium in laptop computers and hand-held devices, this is a serious drawback in hydrogen generators. Venting excess hydrogen gas is typically not an option in these devices due to the obvious fire risks and, in any event, is undesirable in that it reduces the effective yield of the hydrogen generator.

There is thus a need in the art for a hydrogen generator that offers fast response time to the need for hydrogen so that a supply of hydrogen is available on demand. There is also a need in the art for a hydrogen generator that effectively halts the production of hydrogen gas when the demand for hydrogen abates, so that excess hydrogen is not generated. There is further a need in the art for a hydrogen generator with minimum dimensions, weight and space requirements. These and other needs are met by the devices and methodologies disclosed herein.

### BRIEF DESCRIPTION OF THE DRAWINGS

FIG. 1 is a perspective view of a first embodiment of a hydrogen generator in accordance with the teachings herein.

FIG. 2 is an exploded view of the hydrogen generator of FIG. 1.

FIG. 3 is a perspective view of a first embodiment of a hydrogen generator in accordance with the teachings herein.

FIG. 4 is an exploded view of the hydrogen generator of FIG. 3.

FIG. 5 is a perspective view of the embodiment of FIG. 1.

FIG. 6 is a bottom view of the embodiment of FIG. 1.

FIG. 7 is a cross-sectional view taken along LINE 7-7 of FIG. 6.

FIG. 8 is a cross-sectional view taken along LINE 8-8 of FIG. 6.

FIG. 9 is a cross-sectional view taken along LINE 9-9 of FIG. 6.

FIG. 10 is a cross-sectional view taken along LINE 10-10 of FIG. 6.

FIG. 11 is a cross-sectional view taken along LINE 11-11 of FIG. 3.

FIG. 12 is a cross-sectional view taken along LINE 12-12 of FIG. 3.

FIG. 13 is a magnified view of REGION A in FIG. 12.

FIG. 14 is a perspective view of the lower housing body of the hydrogen generator of FIG. 1.

FIG. 15 is a perspective view of the lower housing body of the hydrogen generator of FIG. 1.

FIG. 16 is a perspective view of the lower housing body of the hydrogen generator of FIG. 1.

FIG. 17 is a perspective view of the lower housing body of the hydrogen generator of FIG. 1.

FIG. 18 is a cross-sectional view taken along LINE 18-18 of FIG. 14.

FIG. 19 is a perspective view of the gasket of the hydrogen generator of FIG. 1.

FIG. 20 is a perspective view of the upper housing body of the hydrogen generator of FIG. 1.

FIG. 21 is a perspective view of the upper housing body of the hydrogen generator of FIG. 1.

FIG. 22 is a perspective view of the water/hydride interface of the hydrogen generator of FIG. 1.

FIG. 23 is a perspective view of the water/hydride interface of the hydrogen generator of FIG. 1.

FIG. 24 is a cross-sectional view taken along LINE 24-24 of FIG. 23.

FIG. 25 is a perspective view of the vent cover of the hydrogen generator of FIG. 1.

FIG. 26 is a perspective view of the vent cover of the hydrogen generator of FIG. 1.

FIG. 27 is a perspective view of the reactor plate of the hydrogen generator of FIG. 1.

FIG. 28 is a perspective view of the reactor plate of the hydrogen generator of FIG. 1.

FIG. 29 is a perspective view of the reactor of the hydrogen generator of FIG. 1.

FIG. 30 is a perspective view of the reactor of the hydrogen generator of FIG. 1.

FIG. 31 is a magnified view of a catalytic foam which may be used in the reactors of some of the hydrogen generators made in accordance with the teachings herein.

### SUMMARY OF THE DISCLOSURE

In one aspect a hydrogen generator is provided herein which comprises (a) a reaction chamber equipped with a tortuous passageway for the flow of reactants therethrough, said passageway containing a catalyst disposed on a surface thereof; (b) a fluid; and (c) a hydrogen-containing material which reacts with said fluid in the presence of said catalyst to generate hydrogen gas.

In another aspect, a hydrogen generator is provided herein which comprises (a) a fluid reservoir containing a fluid; (b) a first chamber having a hydrogen-containing material disposed therein, said first chamber being adapted to input a flow of said fluid from said fluid reservoir and to output a mixture of said fluid and said hydrogen-containing material; (c) a reaction chamber containing a catalyst, said reaction chamber being adapted to input said mixture and to react said mixture, in the presence of said catalyst, to evolve hydrogen gas, and being further adapted to output said hydrogen gas and the byproducts of the hydrogen evolution reaction; (d) a separation chamber, downstream from said reaction chamber, which is adapted to separate the hydrogen gas from the reaction byproducts; and (e) a valve movable from a first position in which the flow of fluid along a pathway including the fluid reservoir and the first chamber is enabled, to a second position in which the flow of fluid along the pathway is prevented.

In a further aspect, a hydrogen generator is provided herein which comprises (a) a catalyst; (b) a fluid; (c) a hydrogen-containing material; and (d) a reaction chamber adapted to react a mixture of said fluid and said hydrogen-containing material in the presence of said catalyst to generate hydrogen gas, and being further adapted to separate the generated hydrogen gas from reaction byproducts.

In still another aspect, a hydrogen generator is provided which comprises (a) a catalyst; (b) a fluid; (c) a hydrogen-containing material; (d) a mixing chamber adapted to form a mixture of said fluid and said hydrogen-containing material; and (e) a reaction chamber adapted to react said mixture in the presence of said catalyst to generate hydrogen gas; wherein the hydrogen generator transitions from a first condition when the pressure of hydrogen gas within the reaction chamber is P₁, to a second condition when the pressure of hydrogen gas within the reaction chamber is P₂, where P₂>P₁; wherein the mixing chamber is adapted to generate said mixture when said hydrogen generator is in said first state; and wherein said mixing chamber is adapted to cease generation of said mixture when said hydrogen generator is in said second state.

### DETAILED DESCRIPTION

### A. Overview

It has now been found that the aforementioned needs in the art may be met by the devices and methodologies disclosed herein. In particular, a hydrogen generator is disclosed herein which, in some embodiments, provides hydrogen on demand by rapidly commencing and terminating the hydrogen evolution reaction. Preferably, this is achieved, at least in part, by equipping the hydrogen generator with a low volume, high surface area reactor which contains a tortuous, catalyzed passageway for the flow of reactants therethrough. Due to the extremely small volume of such a reactor, the generation of hydrogen gas can be controlled with precision by controlling the flow of reactants into the reactor.

The hydrogen generator may be configured as a small, compact unit, and may be further configured so that, as reactants are exhausted and the space used to store them is freed up, that space may be utilized for the storage of reaction byproducts. In some embodiments, the hydrogen generator may be configured as a passive unit which is sufficiently small so that it can be placed on the back of the handheld device or incorporated into a laptop computer.

### B. Structure of Preferred Embodiment

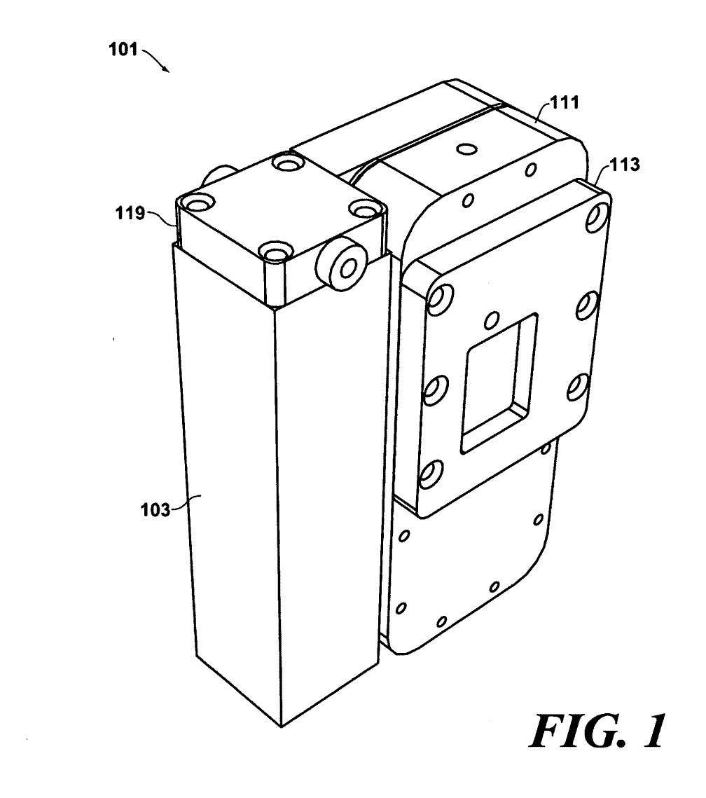

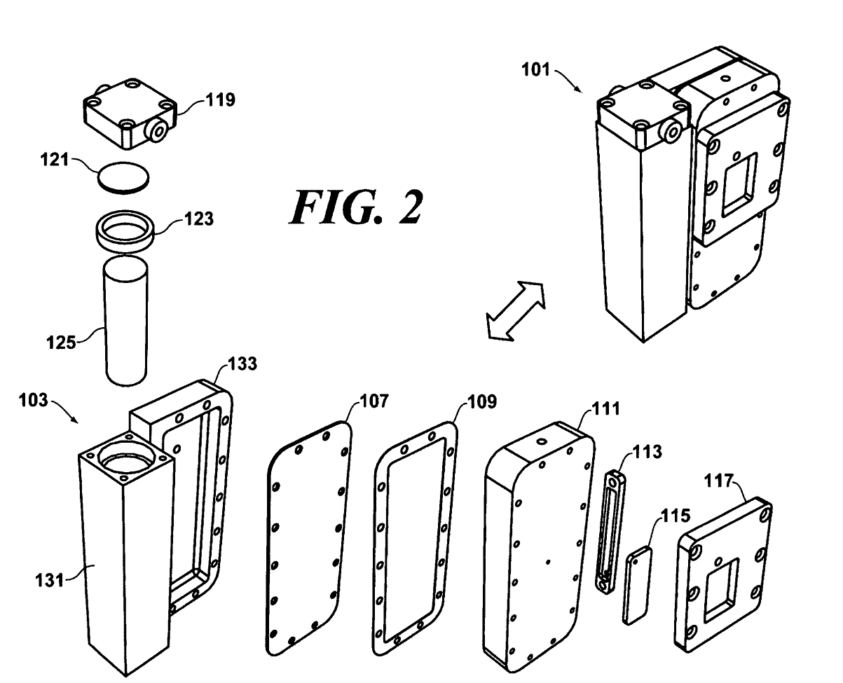

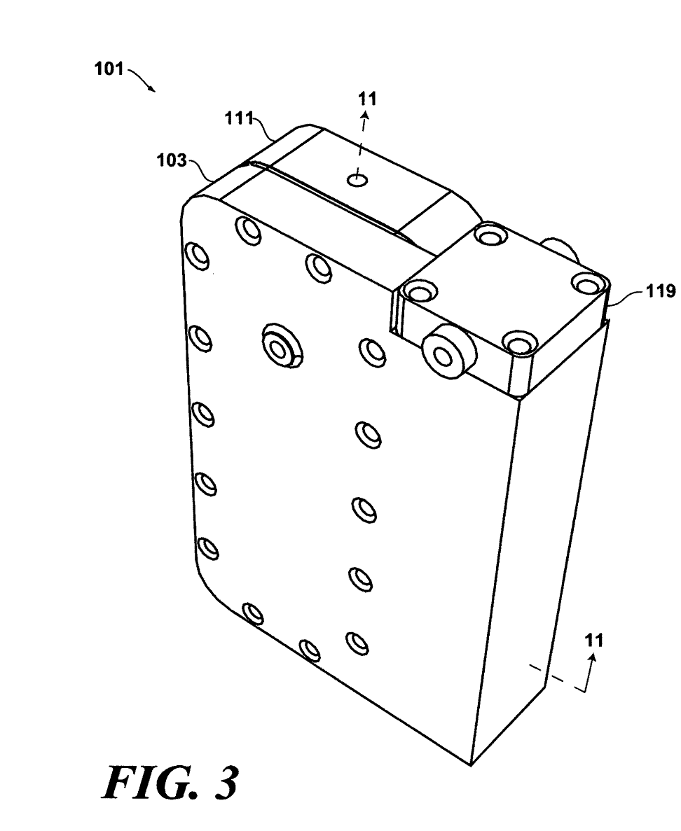

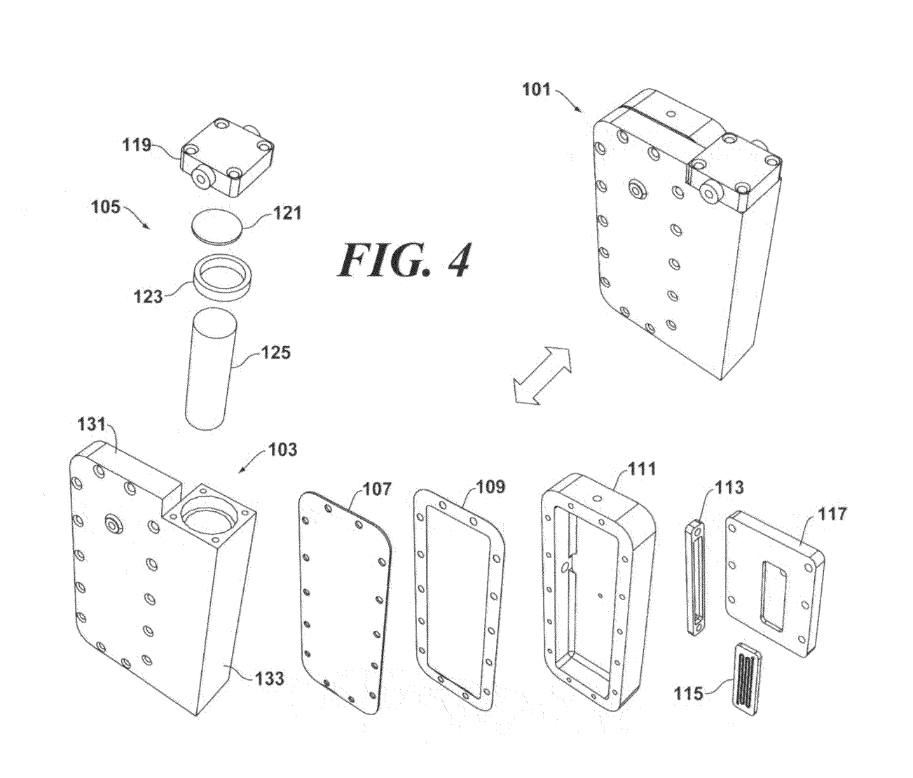

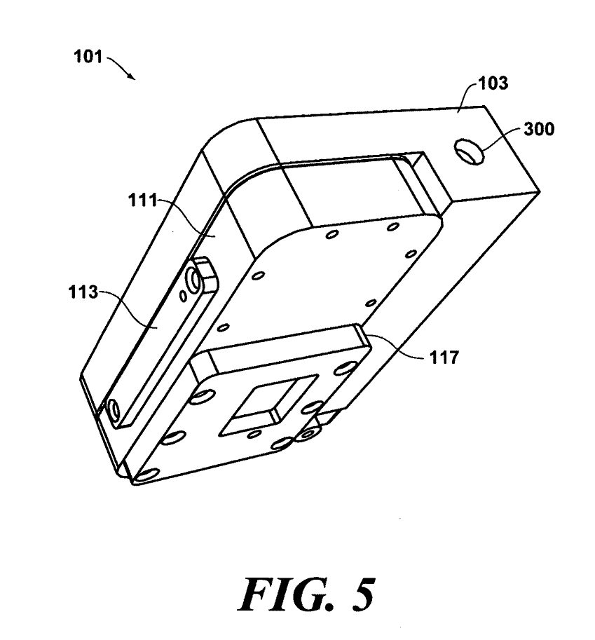

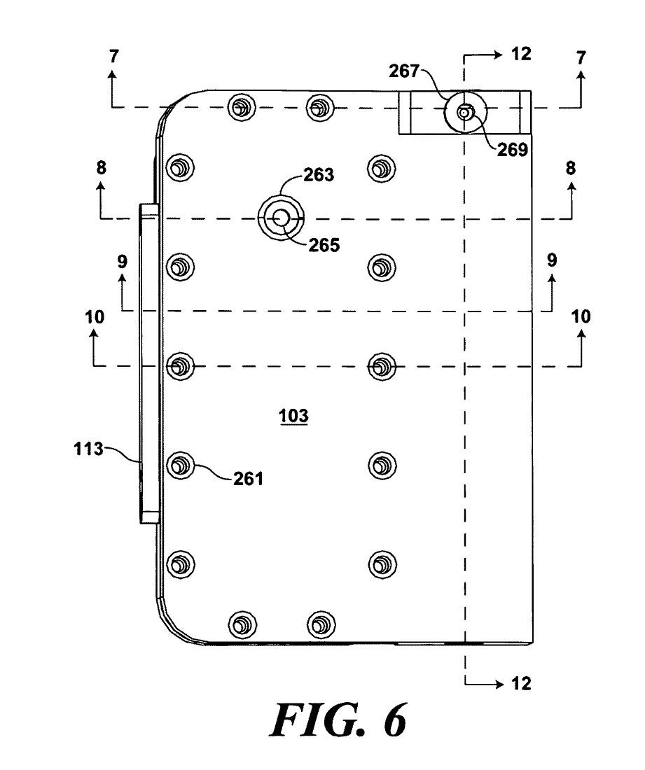

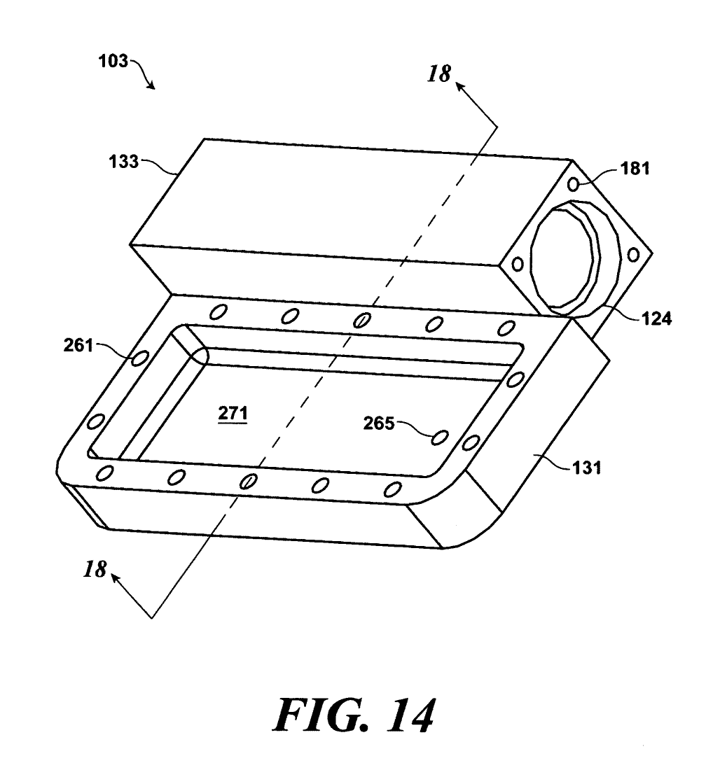

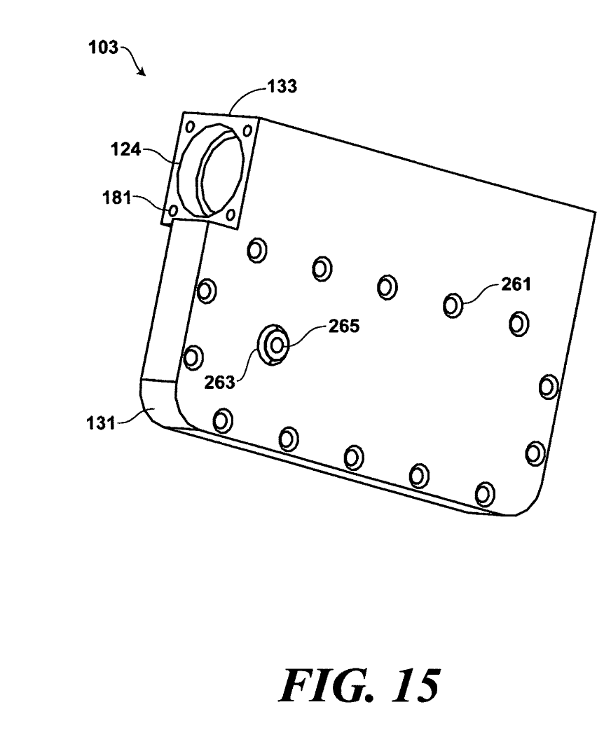

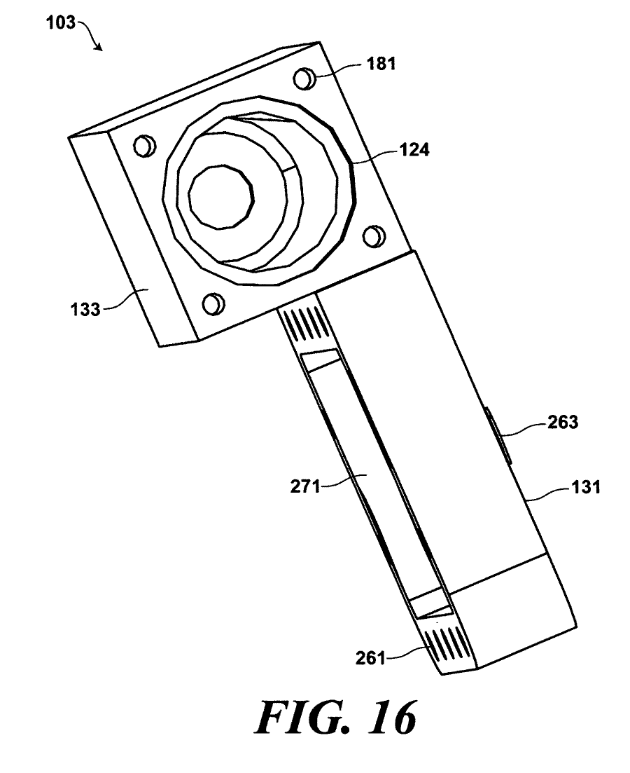

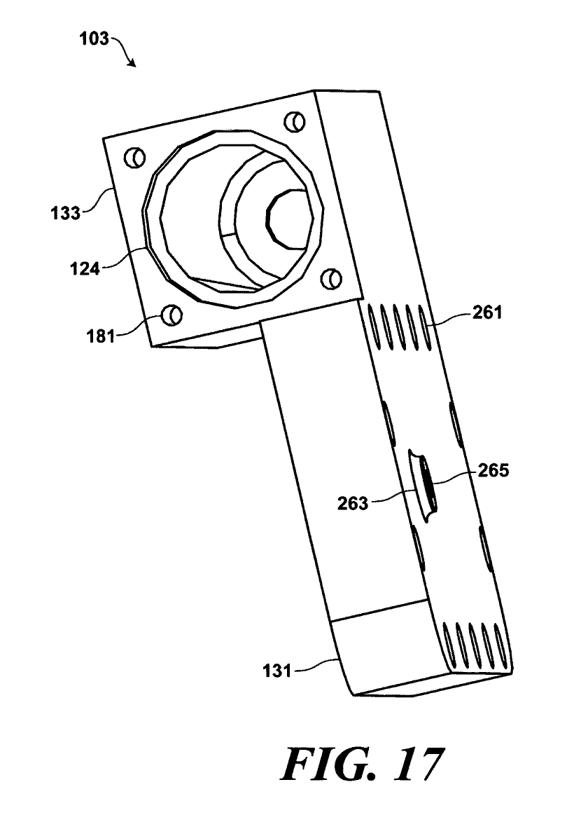

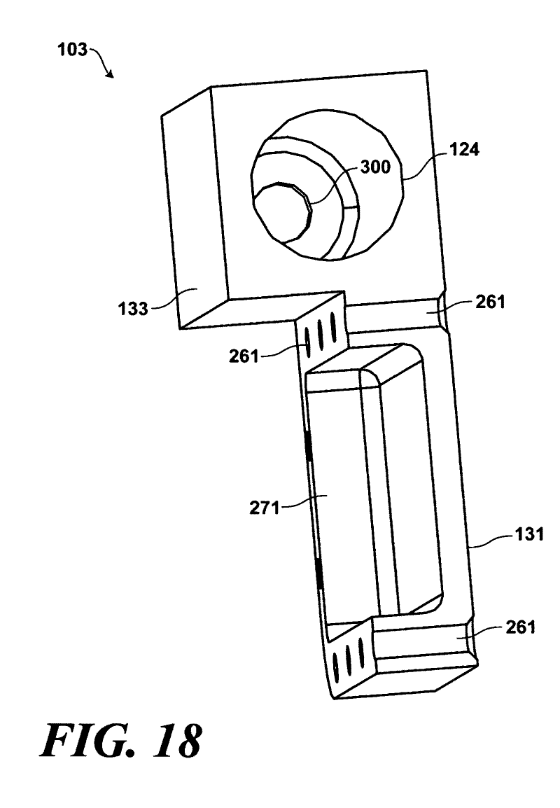

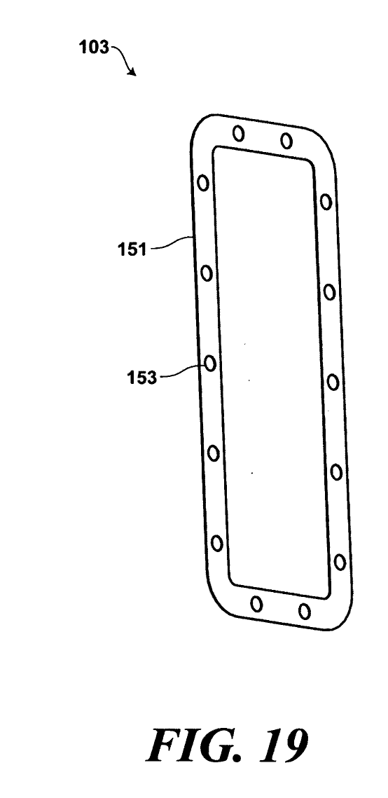

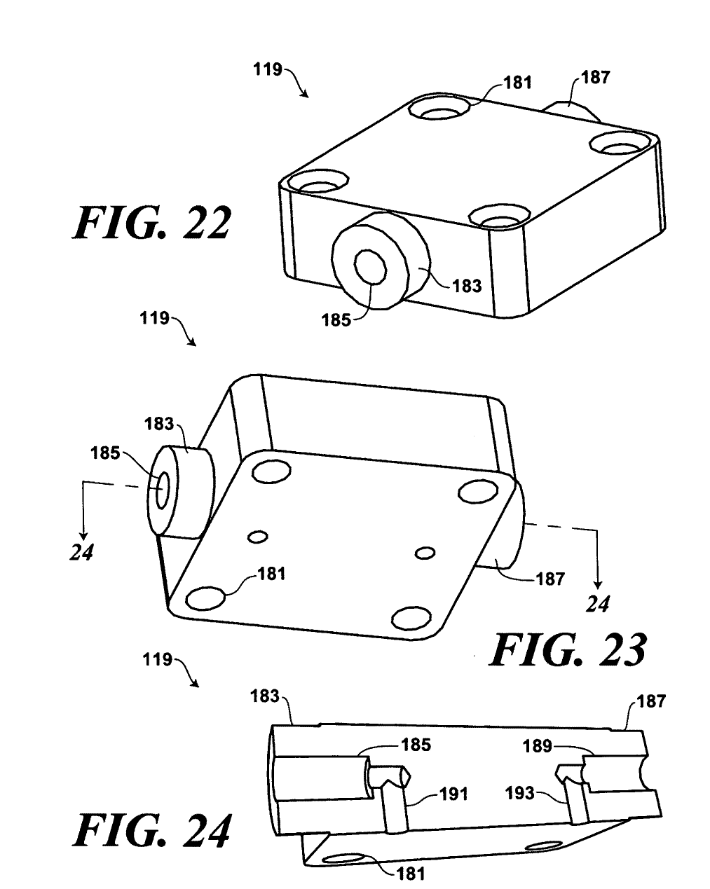

FIGS. 1-30 illustrate a first particular, non-limiting embodiment of a hydrogen generator 101 in accordance with the teachings herein. The overall structure of the hydrogen generator 101 may be appreciated with respect to FIGS. 1 and 3 (which show, respectively, perspective views of the top and bottom of the device), and FIGS. 2 and 4, which are exploded views of FIGS. 1 and 3, respectively. FIGS. 5 and 6 show other views of the hydrogen generator 101, and further illustrate some of the features thereof.

With reference to FIGS. 1-4, the hydrogen generator 101 comprises a lower housing element 103 and an upper housing element 111. The lower housing element 103 comprises a first component 131 which is adapted for the storage of a hydride or other hydrogen-containing material 125 (depicted in this particular embodiment as a hydride fuel rod) and which contains the fuel rod assembly 105. The fuel rod assembly 105 includes a dissolver cap 119, a flow diffuser 121 and a washer 123. The lower housing element 103 also includes a second component 133 which releasably mates with the upper housing element 111 such that a partition 107 and gasket 109 are sandwiched between them. A catalytic reactor 115 is mounted on a major surface of the upper housing element 111 by way of reactor plate 117, and a vent cover 113 is mounted on a lateral surface of upper housing element 111.

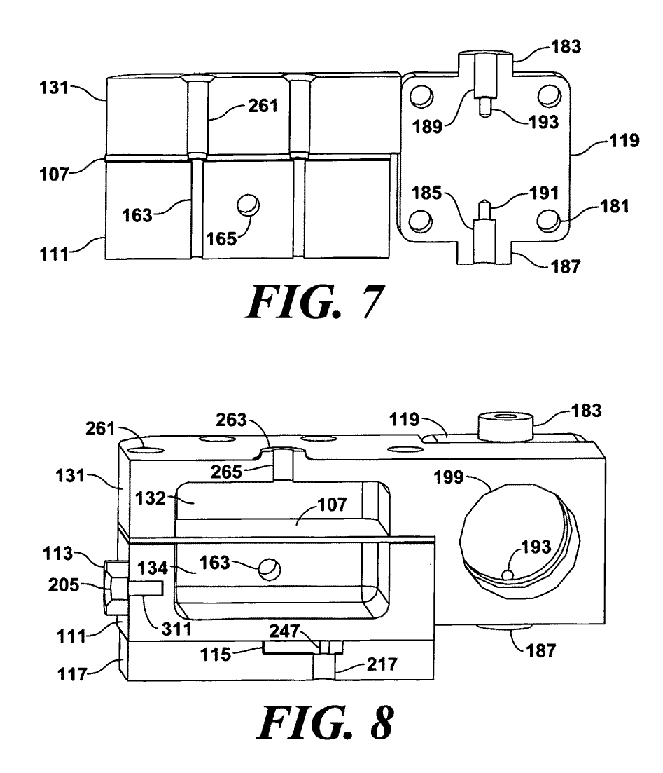

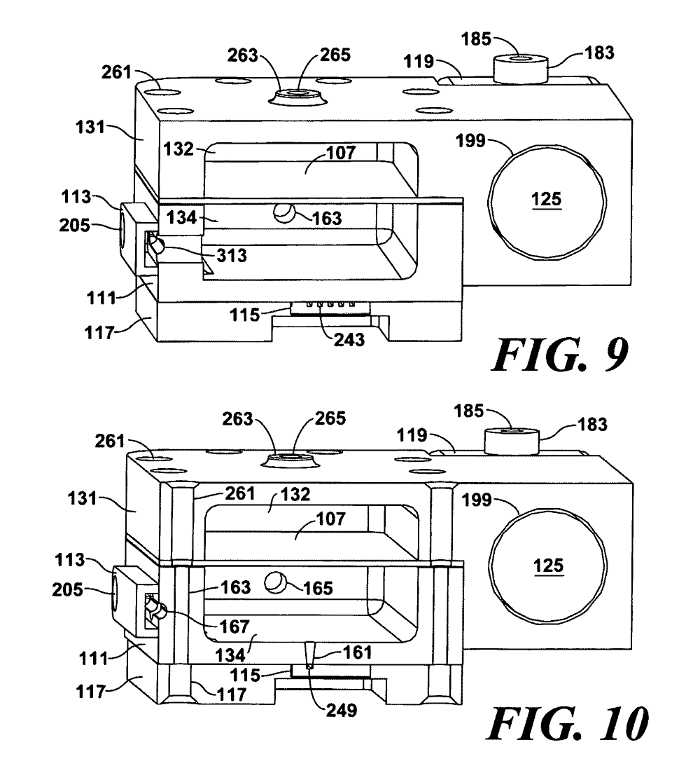

With reference to FIG. 6 (and the various cross-sections thereof depicted in FIGS. 7-11), it can be seen that the partition 107 which is sandwiched between the upper 111 and lower 103 housing elements serves to divide the interior space enclosed therein into first and second compartments, which define a fluid reservoir 132 and a reaction byproducts reservoir 134. The fluid reservoir 132 houses a liquid medium which contains a solvent capable of dissolving a portion of the hydrogen-containing material 125 (see FIGS. 9 and 10) or forming a suspension thereof, and the reaction byproducts reservoir 134 houses the byproducts of the hydrogen generation reaction.

### C. Flow Path in Preferred Embodiment

The flow path through the embodiment of FIGS. 1-30 may be appreciated with reference to FIGS. 8-10 and 14. As seen therein, the hydrogen generator 101 is equipped with a fluid reservoir 132 which contains a fluid (preferably water or an aqueous solution) which will react with the hydrogen-containing material 125 to generate hydrogen gas. Fluid is withdrawn from the fluid reservoir 132 by way of the central aperture 265 of the fluid outlet 263 disposed on the bottom of the hydrogen generator 101. Preferably, the flow of fluid is passive, but in some embodiments, it may be induced or facilitated by one or more pumps or actuators. In some embodiments, the hydrogen generator 101 may be equipped with various flow control devices which maintain a proper, unidirectional flow of fluid out of the fluid reservoir 132.

As fluid is withdrawn from the fluid reservoir 132, it passes through a tube or other conduit (not shown) which connects the fluid outlet 263 of the fluid reservoir 132 to the fluid inlet 183 of the dissolver cap 119. As best seen in FIGS. 12-13 and 23-24, the fluid enters the inlet chamber 185 of the dissolver cap 119, where it passes into inlet channel 191 and contacts the flow diffuser 121. The fluid then moves across the flow diffuser 121, where it dissolves a portion of the hydrogen-containing material 125. The resulting solution or suspension then enters outlet channel 193, from which it passes into the outlet chamber 189 of fluid outlet 187.

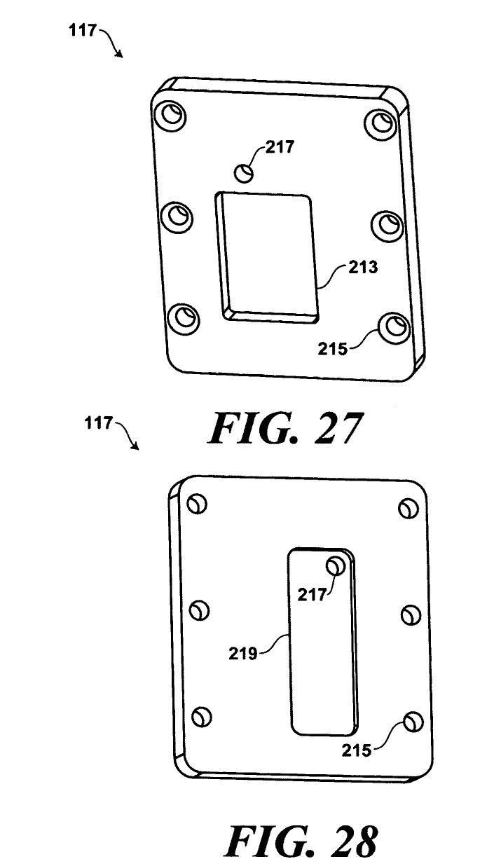

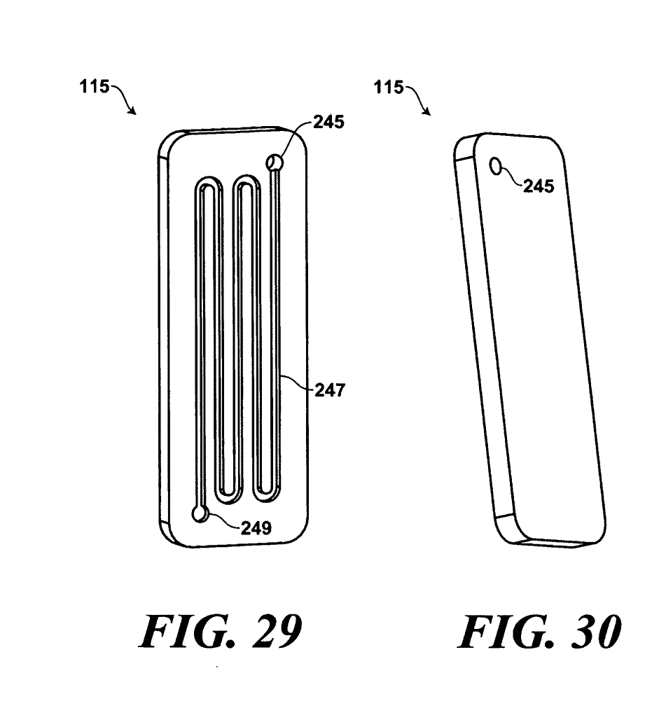

Referring now to FIGS. 27-28, the solution flows from the fluid outlet 187 of the dissolver cap 119 into the solution inlet 217 of the reactor plate 117 by way of a tube or other suitable conduit (not shown). The solution flows from the solution inlet 217 of the reactor plate 117 (see FIG. 8) into the opposing reactor inlet 245 of the catalytic reactor 115 (see FIGS. 29-30). From there, the solution passes through the serpentine channel 247 of the catalytic reactor 115, where it reacts in the presence of a catalyst disposed within the serpentine channel 247 to produce hydrogen gas and reaction byproducts.

The serpentine channel 247 of the catalytic reactor 115 terminates in a reactor outlet 249 which is in open communication with the reaction product inlet 161 of the upper housing element 111 (see FIG. 10). A reaction products receptacle (not shown), which is preferably a bag and which preferably comprises porous or expanded polytetrafluoroethylene (PTFE) or another gas permeable, liquid impermeable material, is housed in the upper housing element and is attached to reaction product inlet 161.

The reacted solution passes through the reaction product inlet 161 of the upper housing element 111 and into the reaction products receptacle. The components of the reacted solution will depend, in part, on the selection of hydrogen-containing material 125. However, if the hydrogen-containing material is sodium borohydride, the reacted solution may contain unreacted sodium borohydride, water, various borates (which can be in various states of hydration), and hydrogen gas. Since the reaction products receptacle is preferably hydrogen permeable, the hydrogen gas egresses through the sides of the receptacle, while the remaining components of the reacted solution remain behind.

After the hydrogen gas passes through the walls of the reaction products receptacle, it collects in the byproducts reservoir 134 in the upper housing element 111 and, if the reactor plate 165 is in an open condition, passes through the reactor plate 165. Various conduits or flow regulators as are known to the art may be attached to, or in communication with, the reactor plate 165 to direct or regulate the flow of hydrogen gas therefrom.

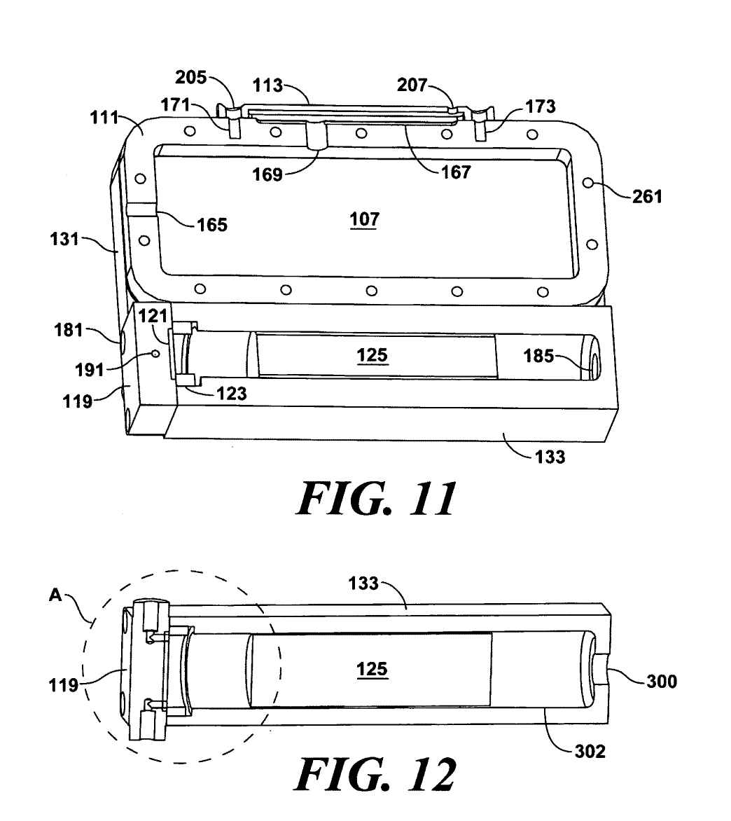

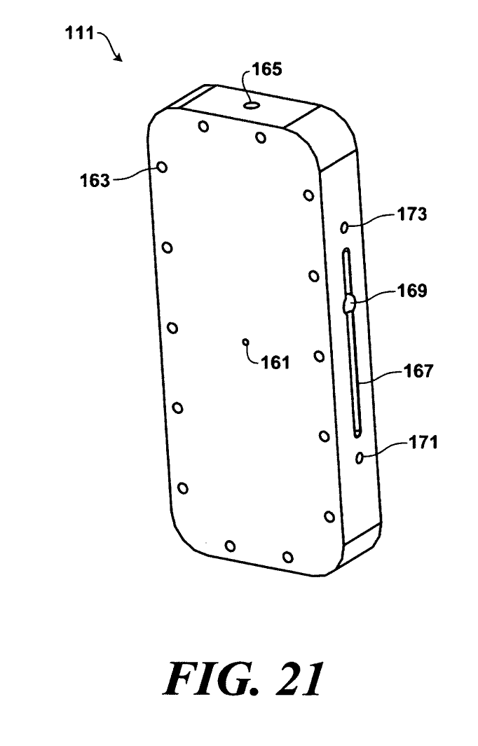

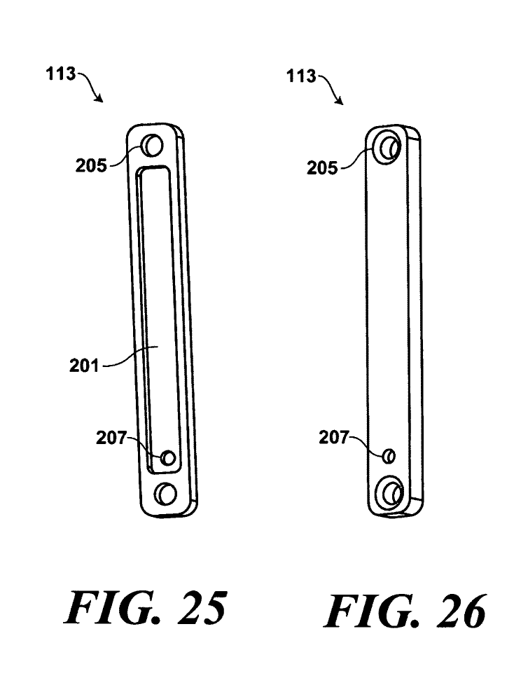

As best seen in FIG. 11, a check valve (not shown) is press fitted into aperture 169 provided in the side wall of upper housing element 111. If the hydrogen pressure inside the upper housing element 111 becomes too great (for example, if the reactor plate 165 is in a closed configuration and the generation of hydrogen gas continues for a period of time, or if the reactor plate becomes obstructed during operation of the hydrogen generator), hydrogen gas will pass through the check valve and into a slot 167 (best seen in FIG. 21) which is covered by the vent cover 113 (see FIGS. 25-26). As seen therein, the vent cover 113 is equipped with a recess 201 which is preferably coextensive with the slot and which is adapted to hold a suitable catalyst (not shown) and the support for that catalyst. The catalyst is capable of converting hydrogen gas into water in the presence of air. The vent cover 113 also contains a flow path separating the catalyst and support from the surface of depression 201, thereby allowing air exposure along the catalyst layer.

Various catalysts may be used with the vent cover 113. For example, the catalyst may be platinum, which may be disposed in a carbon cloth or other suitable media. The vent cover 113 is also equipped with an air inlet 207 such that the recess 201 is exposed to the ambient environment. Air inlet 207 allows air (oxygen) to enter depression to react with hydrogen gas in the presence of the catalyst, thus forming water vapor and eliminating the excess hydrogen.

### D. Dissolver Cap

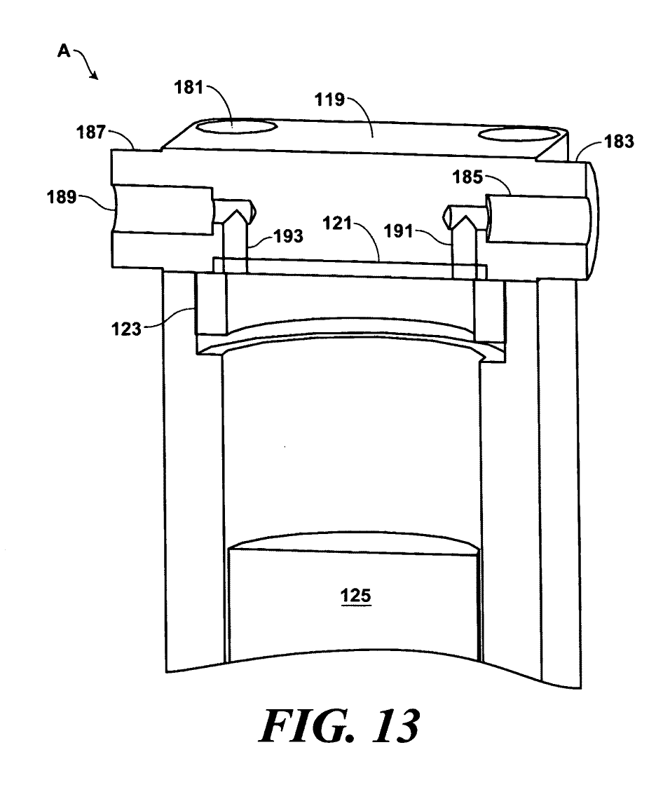

The preferred embodiment of the dissolver cap is illustrated in FIGS. 12-13 and 22-24. As seen therein, the dissolver cap 119 in this particular embodiment is equipped with a fluid inlet 183 and a fluid outlet 187, which are equipped, respectively, with inlet chamber 185 and outlet chamber 189. Inlet chamber 185 is in open communication with inlet channel 191, and outlet chamber 189 is in open communication with outlet channel 193. Flow diffuser 121 (see FIG. 13) is disposed across the openings of inlet 191 and outlet 193 channels on the bottom surface of dissolver cap 119. Flow diffuser 121 serves to disperse fluid from inlet channel 191 across the surface of the fuel rod 125, where it dissolves a portion of the constituent hydrogen-containing material, thereby forming a solution or suspension. The solution or suspension then exits the flow diffuser 121 by way of outlet channel 193.

Flow diffuser 121 is preferably a porous matrix which is preferably situated on the bottom surface of the dissolver cap 119, and which may comprise various materials. These materials include, without limitation, various types of fibrous materials (including various cloths and papers); various particulate media, such as sand, silica gel, alumina, activated charcoal, or clay; various porous matrices, such as frits, sponges, and foams, the later of which are preferably open-celled; various open-celled polymeric materials; various cloths (including metal cloths); and various types of screens and meshes. It will also be appreciated that the flow of fluid across or through the flow diffuser 121 may be facilitated by various features such as grooves, channels, ridges or capillaries. These features may be formed on a surface of dissolver cap 119 or flow diffuser 121, may be formed on a layer of material disposed between either the dissolver cap 119 and flow diffuser 121, or the flow diffuser 121 and the hydrogen-containing material, or may be formed within the dissolver cap 119 or the flow diffuser 121.

Although not depicted in the figures, the hydrogen-containing material 125, which is disposed in cavity 302 of the second component 133 of the lower housing element 103, is preferably maintained in pressing engagement with the flow diffuser 121. In some embodiments, this may be achieved by way of a spring or piston or the like which may be disposed within the first component 131 of the lower housing element 103, and which may be adapted to push or pull the hydrogen-containing material against the flow diffuser 121. In other embodiments, this may be achieved by disposing a gas or volatile liquid into the first component 131 of the lower housing element 103, and preferably within an inflatable bladder or package disposed between the hydrogen-containing material 125 and the bottom of the first component 131 of the lower housing element 103. In variations of such an embodiment, the gas or volatile liquid may be maintained within a piston housed within the first component 131 of the lower housing element 103 and which presses against the hydrogen-containing material 125.

As seen in FIG. 12, cavity 302 of the second component 133 of the lower housing element 103 is provided with a hole 300. This hole 300 may be used during manufacturing or recycling for various purposes. For example, in embodiments wherein a spring is used to apply pressure to the hydrogen-containing material 125, the hole 300 may be utilized to retract the spring while the hydrogen-containing material 125 is loaded, after which the hole 300 may be sealed or plugged, or may be utilized to maintain the cavity 302 at atmospheric pressure. In embodiments in which the pressing engagement is provided by a gas or volatile liquid, the hole 300 may be utilized as a fill port, after which it may be sealed or plugged.

Various gasses or mixtures of gasses may be utilized in the foregoing embodiments within the first component 131 of the lower housing element 103. Such gasses are preferably inert or non-flammable gasses, and include, for example, argon, helium, nitrogen, and carbon dioxide, but may also include gasses such as hydrogen or air. Volatile liquids which may be utilized in the foregoing embodiments include, but are not limited to, volatile hydrocarbons such as butane or propane, volatile fluorocarbons, chlorofluorocarbons, or fluorinated ethers, volatile alkyl halides, and various mixtures of the foregoing. The use of volatile liquids may be particularly advantageous in some embodiments, since the vapor pressure of the liquid would remain more or less constant as the free volume of the first component 131 of the lower housing element 103 changes due to consumption of the hydrogen-containing material 125.

With reference to FIG. 13, the first component 131 of the lower housing element 103 is provided with a recess 124 within which the washer 123 is seated. The diameter of the washer 123 is selected such that inlet 191 and outlet 193 channels are disposed within the circumference of the washer 123. Hence, when the dissolver cap 119 is fastened to the lower housing element 103 through suitable fasteners (not shown) disposed in apertures 181, a gas-tight seal is achieved.

### E. Catalytic Reactor

1. Design

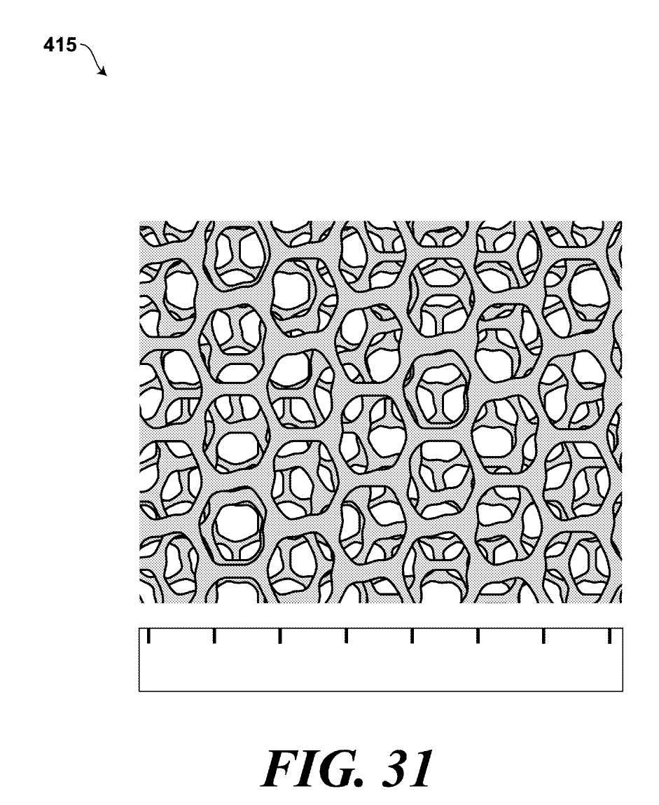

The catalytic reactor which is utilized in the hydrogen generators disclosed herein is preferably configured as a low volume, high surface area reactor which accelerates the flow of the reaction products into the reacted solution receptacle. The dimensions of the reactor may be selected to optimize or maximize residence time of the mixture in the reactor, thereby ensuring optimum or maximum transfer of the heat of reaction to the reactor. One particular, non-limiting embodiment of a catalytic reactor 115 which may be used in the hydrogen generators disclosed herein is depicted in FIGS. 29-30. Another particular, non-limiting embodiment of a catalytic reactor 415 which may be used in the hydrogen generators disclosed herein is depicted in FIG. 31.

2. Microfluidic Flow Channel Reactors

In some embodiments, the reactor may comprise a microfluidic flow channel which may be etched, carved, molded, or machined into a substrate. One particular, non-limiting embodiment of such a reactor is depicted in FIGS. 29-30. The flow channel in such embodiments is preferably tortuous, as exemplified by the serpentine channel 247 of the device depicted in FIGS. 29-30, since such a flow channel may be utilized to maximize or optimize residence time in the reactor, thus ensuring a more complete reaction of the reactant materials. However, it will be appreciated that embodiments are also possible in which the flow channel is not tortuous and may even be minimized. Such embodiments may be utilized, for example, with more reactive materials and/or more highly effective catalysts, or in other embodiments where a longer residence time in the reactor is either unnecessary or undesirable.

In some embodiments, this flow channel may be defined using masking and etching processes known to the semiconductor arts. After the flow channel is formed, a suitable catalyst may be applied to the surfaces of the flow channel. Preferably, this catalyst is applied along the entire length of the flow channel, though in some embodiments, the catalyst may instead be applied only to selected portions of the flow channel.

3. Reactors Based on Foamed Substrates

In some embodiments, the reactor may comprise one or more porous materials, one or more surfaces of which may contain or comprise a catalytic material. Such porous materials may include, without limitation, various types of fibrous materials (including various cloths and papers); various particulate media, such as sand, silica gel, alumina, activated charcoal, or clay; various porous matrices, such as frits, sponges, and foams, the later of which are preferably open-celled and may be honeycombed; various open-celled polymeric materials; various cloths (including metal cloths); and various types of screens and meshes. Such reactors, or the components or substrates thereof, may be made, for example, by plating, depositing, coating, or treating one or more surfaces of a suitable porous substrate, foam or cellular material with a suitable catalyst; by laminating, gluing, attaching, or otherwise adhering together multiple sheets, layers or portions of a porous material (either before or after application of a catalyst, if needed) such as, for example, a mesh, screen, or fibrous mass; or by expanding or increasing the porosity of a substrate or catalytic material through the use of etchants, gases, volatile liquids, temperature, pressure or phase changes, decomposition reactions, and the like. Various combinations of the foregoing materials and processes may also be utilized.

In one particular, non-limiting embodiment of a reactor made in accordance with the teachings herein, a metal (preferably nickel), open-celled foam is provided. A specific, non-limiting example of such a foam is depicted in FIG. 31 (the dimensions on the ruler shown are 1/32 of an inch, or about 794 microns). The hydrogen generator 101 of FIGS. 1-30 may be equipped with a foam reactor by, for example, replacing reactor 117 with a similarly sized portion of a suitable catalyzed foam. The open-celled structure of the foam provides for a turbulent flow through the reactor. Hence, as with the previously described embodiments utilizing a serpentine flow path, the flow path afforded by the foam is tortuous. This serves to increase the residence time of the reactants in the reactor while also increasing the exposure of the reactants to the catalyst, thus facilitating a more complete reaction of these materials.

The average pore or cell diameter of the foam may be manipulated to achieve a desired flow rate of reactants through the foam. Various factors may be considered in selecting a desired or optimal cell size for a particular application. For example, if the average cell diameter is too small, the reactants may clog the cells of the reactor, thereby hindering its operation. In addition, if the average cell diameter is too small, the pressure drop across the reactor may be too large to be conducive to a proper flow rate, and the weight of the reactor may also be too large. Furthermore, the reproducible fabrication of the reactor (and hence the ability to scale the fabrication process) becomes more challenging as average cell diameters decrease. On the other hand, if the average cell diameter is too large, a substantial amount of the reactants may pass through the reactor without reacting, and the turbulence of the flow through the reactor may be diminished to an undesirable level.

The optimum average cell diameter may vary from one application to another depending, for example, on such factors as the specific reactants involved, the choice of catalyst, the degree of saturation of the reactant solution (if one is used), the rate of reaction, the byproducts formed from the hydrogen-generation reaction, the hydration states available to the reactants or byproducts, and the reaction conditions, including the temperature and pressure inside of the reactor. However, in a typical embodiment, the foam reactors used herein will have an average cell diameter which is typically within the range of about 85 μm to about 1700 μm, preferably within the range of about 125 μm to about 1000 μm, more preferably within the range of about 200 μm to about 500 μm, even more preferably within the range of about 250 μm to about 450 μm, and most preferably within the range of about 300 μm to about 400 μm.

The optimum average cell density and surface area may also vary from one application to another, for the various reasons noted above. Typically, however, the surface area of the uncatalyzed foam (measured as the ratio of real surface area to geometric volume) will be within the range of about 10 to about 120 cm²/cm³, preferably within the range of about 20 to about 100 cm²/cm³, more preferably within the range of about 30 to about 70 cm²/cm³, and most preferably within the range of about 35 to about 55 cm²/cm³. Application of a catalyst to the foam will typically increase its surface area, with the amount of increase depending, in part, on the particular catalyst utilized, the method of application, and the amount of catalyst loading. Typically, however, application of the catalyst to the foam will increase its surface area by at least 10 fold, preferably by at least 100 fold, more preferably by at least 200 fold, and most preferably by at least 250 fold. In some applications, it may be desirable for the surface area of the uncatalyzed and catalyzed foams to be as large as possible without adversely affecting the operation of the reactor (e.g., by inducing clogging of reactants).

As an example of the foregoing considerations, in one specific embodiment of a reactor made in accordance with the teachings herein, a nickel foam was utilized as the substrate, and was catalyzed with cobalt boride. The nickel foam had a foam density of 0.513 g/cm³ and a surface area between 30 and 50 cm²/cm³, where the surface area was determined as a function of strut width and pore density using the methodology described in D. L. Duan, R. L. Zhang, X. J. Ding, and S. Li, Mat. Sci. & Tech. 22(11), 1364-1367 (2006). The BET surface area of the catalyzed foam was determined to be about 1.66 m²/g, and the density of the foam was determined to be 0.590 g/cm³. Hence, the catalyzed foam had a surface area of 0.978 m²/cm³, or over 240 times the surface area of the base foam. With the catalyst representing 24.4% of the material present, the surface area of the catalyst was determined to be 4.015 m²/cm³ (here it is to be noted that, for the purposes of estimating the surface area of the catalyst, the surface area of the base material was ignored, since it represented less than 4% of the standard deviation for the catalyzed material).

In some embodiments of foam or porous reactors made in accordance with the teachings herein, the average cell diameter of the reactor may vary from one region of the reactor to another. For example, a gradient of cell diameters may be established across a portion of the reactor such as, for example, across the length or width of the reactor. In some embodiments, a distribution of cell diameters may be utilized, with the distribution characterizable by a statistical distribution function and selected to achieve a set of desired properties.

In still other possible embodiments, the hydrogen-containing material itself may be used as a support for the catalyst. For example, the hydrogen-containing material may be synthesized as, or converted into, a foam or other porous substrate. This may be accomplished, for example, by extruding the hydrogen-containing material as a molten mass having a gas dissolved therein (or generated therein by, for example, a thermal decomposition reaction) to form an expandable foam, by treating a solid mass of the hydrogen-containing material with a solvent to form open pores therein, or by other suitable means known to the art. The catalyst may then be applied to the surfaces of the substrate. For example, the catalyst may be applied in the gas phase. The catalyst may also be applied in a liquid or fluidic medium or solution that suppresses or inhibits reaction of the hydrogen-containing material in the presence of the catalyst. The catalyst may also be applied under conditions, such as, for example, conditions of temperature or pH, that suppress or inhibit reaction of the hydrogen-containing material in the presence of the catalyst. In use, water or another liquid or fluidic medium may be flowed through the reactor to generate hydrogen gas.

As noted above, in some embodiments, reactors may be made in accordance with the teachings herein by laminating, gluing, attaching, or otherwise adhering together multiple sheets, layers or portions of a porous material such as, for example, a mesh, screen, or fibrous mass. As a specific, non-limiting example of this type of approach, multiple layers of screening, which may be formed, for example, out of metals, polymers, ceramics, or other suitable materials, may be assembled into stacks of the desired dimensions. The layers may be held together by a frame or by other such means. A suitable catalyst may be applied to the screening, either before or after it is assembled into a stack.

4. Reactor Substrate Materials

Reactors for use in the devices and methodologies described herein may be made from various materials. These materials may be thermally conductive or thermally insulating.

One class of particularly preferably thermally conductive materials which may be used in the fabrication of the reactor includes ceramics and, in particular, high surface area, porous ceramics. Such materials include, but are not limited to, ceramics based on nitrides, carbides, and various mixtures of the two, such as ceramics comprising boron nitride (BN), aluminum nitride (AlN), aluminum silicon carbide (AlSiC), or various mixtures of the foregoing. Other thermally conductive materials which may be used in the fabrication of the reactor include graphite, graphite composites, and various metals or metal alloys.

Various thermally insulating materials may also be used in the construction of the reactor. This class of materials also includes various high surface area, porous ceramics, including those comprising zirconia, alumina (AlO₃), and various mixtures of the foregoing.

5. Reactor Heating Elements and Methods

a. Active Heating

In the various catalytic reactors disclosed herein, it is preferred to heat the liquid reactant in the presence of the catalyst (or to heat the catalytic surface or reactor itself) since, at least when sodium borohydride is used as the hydrogen-containing material, the hydrogen generation reaction is typically catalyzed with greater efficiency at higher temperature levels. Moreover, the distribution of byproducts at higher temperatures (e.g., around 90° C.) will typically be centered around lower hydration states than is the case when the hydrogen generation reaction occurs at lower temperatures. It will be appreciated that, in various embodiments, suitable heating may be implemented by heating the fluid, heating the catalyst, and/or heating the reactor. In some embodiments, heating may also be utilized as a solubility enhancer for the hydrogen-containing material.

In one possible embodiment, a resistive wire or other heating element is incorporated into the flow channel (element 247 in the particular reactor depicted in FIG. 29) of the reactor. This heating element may comprise Nichrome (a nickel chromium alloy), tungsten, or another suitable material with sufficient resistivity to generate heat when a voltage is applied across it. A voltage is then applied to the heating element when the device is turned on (or at suitable intervals during the operation of the device), which heats the heating element and the surrounding surfaces or fluid to promote fast start-up times for the reactor.

In another possible embodiment, the reactor comprises a composite structure which includes an insulating base material (such as a plastic) which is coated with an electrically conductive, high resistance material such as chrome. The high resistance material is then coated with a layer of an electrically insulating material and a layer of catalyst. In such an embodiment, heating may be supplied on demand by applying a voltage across the electrically conductive layer.

In some embodiments, the reactor may contain a channel (such as element 247 in the embodiment of FIG. 29) which may be machined, etched, carved, or molded into the surface of a heating element, such as a PTC (positive thermal coefficient) thermistor. Such a thermistor may comprise, for example, barium titanate. In some embodiments, the catalyst may be applied directly to the heating element, while in other embodiments, an electrically insulating material may be deposited on the heating element, followed by deposition of the catalyst.

In the case of hydrogen generators that are to be used in conjunction with fuel cells in laptop computers or handheld electronic devices, the dimensions of the catalytic reactor will frequently be sufficiently small such that flash heating of the liquid reactant can be economically performed in the presence of the catalyst, using techniques similar to those developed for thermal inkjet printers. Such flash heating may be utilized to generate discrete bubbles of hydrogen gas that span the diameter of the fluid channel through the reactor, and that may be readily adsorbed from the fluid flow in the reactor through a hydrogen-permeable membrane. Hence, flash heating can serve the simultaneous purposes of improving the efficiency of the hydrogen generation reaction, reducing the amount of water consumed by reaction byproducts, and facilitating the separation of hydrogen gas from reaction byproducts and unreacted materials. Moreover, the generation of bubbles via flash heating may be used in the devices and methodologies described herein, either alone or in combination with other such mechanisms as piezoelectric actuators, to push (or pull) liquid reactants or other materials through the reaction zone and through other parts of the device.

In one such embodiment, the catalytic reactor may be fabricated with a series of tiny, electrically-heated chambers that may be constructed, for example, through photolithography. In use, the reactor runs a pulse of current through the heating elements, which rapidly heats the liquid reactant in the vicinity of the catalyst. This results in the formation of a bubble of hydrogen which, as it is adsorbed through an adjacent hydrogen-permeable membrane, sucks a further portion of liquid reactant into the catalytic reactor. Hence, the flash heater acts as an effective pumping mechanism while hydrogen is being generated, and further provides a convenient means by which the rate of hydrogen evolution may be scaled up or down in accordance with demand.

It will be appreciated that the flash heating methods described above may be implemented in a variety of ways. For example, a positive temperature coefficient thermistor may be provided which is integrated with, or which controls, the heating devices. Such a thermistor may be designed with an electrical resistance that is low at room temperature, but which becomes very high at some desired strike temperature. Hence, the thermistor will efficiently heat the liquid reactants up to the strike temperature, and will then effectively shut off.

In some embodiments, electronic circuitry controlling the catalytic reactor may be incorporated into the hydrogen generator. In other embodiments, some, or the bulk of, this circuitry may be integrated into a hydrogen fuel cell that is coupled to the hydrogen generator, or into the host device. This latter type of embodiment may be particularly advantageous in applications where it is desired to fashion the hydrogen generator as a disposable device. The electronic circuitry may also comprise various piezoelectric pumps which may be used to control the flow of reactants through the hydrogen generator.

The electronic circuitry may further include sensors which are adapted, for example, to sense changes in the volume of components of the hydrogen generator due, for example, to the accumulation of hydrogen gas. It will be appreciated that such circuitry may be utilized to monitor the status of the hydrogen generator, and/or to control the hydrogen evolution reaction in accordance with the existing demand for hydrogen.

b. Passive Heating

The reactor, solution, and/or catalyst may also be heated passively in various embodiments in accordance with the teachings herein. Such passive heating is advantageous in that it does not require an external power supply.

In some embodiments, hydrogen combustion may be used to produce heat inside of the reactor. Such embodiments may be utilized, for example, in devices where the hydrogen generator is being used in combination with, or is integrated with, a hydrogen fuel cell. In these embodiments, hydrogen gas reacts with oxygen in the presence of a catalyst (such as Pt) to generate heat. The heat may then be utilized to heat the reactor, fluid and/or catalyst. In some embodiments, hydrogen combustion may be made to occur inside the reactor during generation of the hydrogen gas by introducing oxygen or air into the feed stream entering the reactor.

In some embodiments, hydrogen combustion may also be used to produce heat outside of the reactor. In such embodiments, a surface coated with a suitable catalyst (such as, for example, Pt) may be mounted or positioned outside of the reactor where it is exposed to air, but is still in thermal contact with the reactor body. A portion of hydrogen gas may then be flowed over the surface such that the resulting combustion will heat the reactor.

In other embodiments, various chemical additives may be added to the hydrogen-containing material such that, when water or another fluid medium contacts the hydrogen-containing material, it dissolves a portion of the chemical additive via an exothermic process. The heat released by this process thus heats the resulting solution. Examples of chemical additives which may be used for this process include, but are not limited to, calcium oxide (CaO). The heat released by such an additive may be useful not only in heating the solution before it enters the reactor, but also in increasing the solubility of the hydrogen-containing material in the liquid medium.

5. Reactor Insulation Materials

For reasons noted above, it is preferable to run the catalytic reactor at elevated temperatures. Accordingly, the reactors employed in the devices and methodologies described herein are preferably thermally insulated to retain the heat generated by the exothermic hydrogen generation reaction. Various materials may be used for this purpose. These materials include, for example, various aerogels, such as those based on silica; various foams, such as syntactic (glass) foams and aerated or cellular plastics or polymeric materials; and various ceramics. In some embodiments, a gap, which may be subject to a vacuum or filled with air or a gas, may be provided around the reactor for a similar purpose.

### F. Receptacle

Various bags and other receptacles or containers may be used to receive the reaction products and byproducts in the hydrogen generators described herein. Preferably, at least a portion of these receptacles comprise a material which is both gas permeable and liquid impermeable. More preferably, at least a portion of these receptacles comprises a material, such as porous or expanded polytetrafluoroethylene (PTFE), which is both gas permeable and hydrophobic.

The reacted solution receptacle may be fabricated through a number of different processes. For example, if the receptacle comprises PTFE, it may be constructed through thermal sealing or welding of multiple layers of porous or expanded PTFE (ePTFE). This may be accomplished, for example, by pressing multiple layers of ePTFE against a rubber backing using a heated or ultrasonic hot tool or die, or by pressing multiple layers of ePTFE between the heated or ultrasonic surfaces of a tool or die.

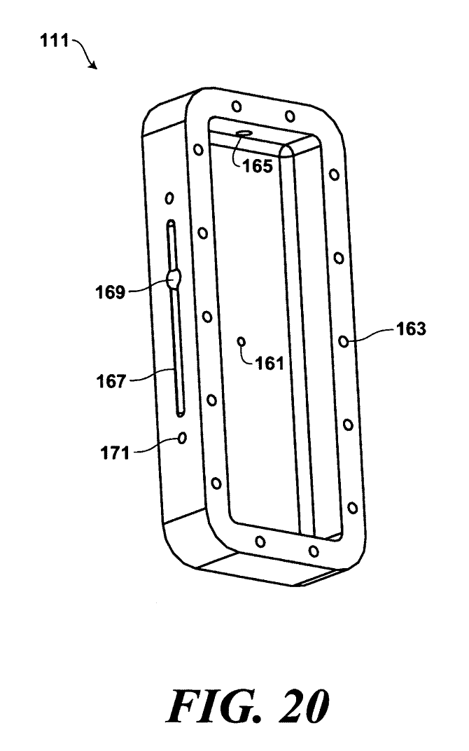

The reacted solution receptacle may be attached to the reaction product inlet (element 161 in the embodiment of FIG. 20) in various ways. For example, the receptacle may be a bag which is made partially or wholly from ePTFE. Such a bag may be attached to a tube or other suitable receptacle inlet through welding or thermal sealing by using a hot or ultrasonic tool pressed against a portion of the bag which has been placed on or around the receptacle inlet. The receptacle inlet may then be mechanically coupled with the reaction product inlet using various suitable techniques as are known to the art.

For example, the receptacle inlet and the reaction product inlet may have complimentary threaded surfaces that can be rotatingly engaged to achieve a tight seal between the two, or the two inlets may be press fitted together. In other embodiments, one or both of these inlets may have a protrusion or other surface feature which releasably engages a surface or feature on the other inlet to maintain the two inlets in a coupled relationship. In still other embodiments, the receptacle may be mechanically attached to the upper housing element 111 or to the reaction product inlet 161 thereof via a press-in ferrule. In further other possible embodiments, the receptacle may be a bag which is attached by bonding or through the use of an adhesive to the upper housing element 111, and in addition or in the alternative, the receptacle inlet may be attached to the reaction product inlet 161 by bonding or through the use of an adhesive.

In some embodiments, the connection between the reaction product inlet 161 and the receptacle may be adapted to allow easy release of solidified materials that might otherwise block the flow of reacted solution into the receptacle. This may be accomplished, for example, by tapering the inner diameter of any such connector such that the inner diameter increases as one proceeds along the axis of the connector in the direction of the receptacle. Some embodiments may also utilize a heated tube or wire, or a tube or wire which conducts heat from the reactor or another heat source.

In other embodiments, such blockages may be avoided or mitigated by providing a crystal growth promoter on a portion of the interior surface of the receptacle spaced apart from the entrance into the receptacle. Such crystal growth promoters may be chemical or mechanical in nature. For example, the crystal growth promoter may comprise seed crystals which are located in a portion of the interior of the receptacle. The crystal growth promoter may also comprise a roughened surface which is more conducive to crystal growth than the surrounding surfaces. Such a surface may be achieved through mechanical abrasion or by chemical etching, or by use of an inherently porous medium.

In some embodiments of the devices disclosed herein, either or both of the external surface of the reacted solution receptacle and the interior surface of the byproducts reservoir 134 may be provided with textured surfaces. Such surfaces prevent blockage of hydrogen permeation through the walls of the reacted solution receptacle as might occur if these two surfaces were smooth and pressed against each other. Such texturing may, for example, include a roughened surface, an open mesh, an open-celled matrix, a series of grooves or protrusions, or other such features suitable for keeping the two surfaces spaced apart from each other and/or for providing pathways for the egress of hydrogen gas.

In some embodiments, the reacted solution receptacle may be treated, coated or provided with a cobalt salt or other suitable catalytic material to induce the reaction of any unreacted borohydride or other hydrogen containing material. In some variations of this embodiment, a suitable means may be provided for capturing any hydrogen gas so generated and storing it or rerouting it so that it can be added to the hydrogen stream exiting the hydrogen generator. In other variations of this embodiment, a second catalyst may be provided to convert any hydrogen so generated into water. This may be accomplished, for example, by providing such a catalyst in the reacted solution receptacle, or by routing the hydrogen to the vent cover 113 (see FIGS. 25-26) where it may react with the catalyst disposed therein.

### G. Fluid Reservoir

In some embodiments of the devices disclosed herein, the fluid or liquid medium used to create the solution of hydrogen-containing material may be disposed in a bag or other receptacle inside of fluid reservoir (shown as element 132 in the embodiment of FIGS. 8-10). In some embodiments of the devices disclosed herein, the surfaces of the fluid receptacle may be provided with one or more textured portions or meshes to prevent collapse of the receptacle over the fluid outlet (element 263 in the embodiment of FIG. 8) prior to complete evacuation of the fluid receptacle. Preferably, this surface texturing is provided in the vicinity of the fluid outlet.

In other embodiments, a similar end may be achieved by vacuum forming the receptacle, either before or after it is placed in the fluid reservoir. Such vacuum forming may include one or more thermal cycles. Alternatively, a similar effect may be achieved by heat stamping, or through the use of other such methods as are known to the art.

In still other embodiments, the possibility of collapse of the receptacle around or over the fluid outlet 263 may be reduced or eliminated through strategic location of the fluid outlet 263 within the fluid reservoir 132. This may be accomplished, for example, by disposing the fluid outlet 263 along a corner or edge of the fluid reservoir 132.

In some embodiments, it may be desirable to design the receptacle so as to avoid or minimize the accumulation of gases therein and/or the incidence of bubble formation. Since hydrogen gas may accumulate within the reservoir by diffusing through the walls of the receptacle, in some embodiments, the receptacle may be metallized with aluminum or other suitable metals to prevent this from happening. In variations of this embodiment, other materials which have low permeability to hydrogen may be substituted for such metallization. In some embodiments, the fluid may also be degassed prior to or after being placed in the receptacle to remove, or reduce the concentration of, any gasses dissolved therein.

In some embodiments, the fluid within the fluid receptacle may be provided with a suitable (preferably water soluble) catalyst, such as, for example, a cobalt salt, which will cause the hydrogen containing material to react with the fluid. The catalyst, or the chemistry of the solution, may be selected so that this reaction occurs at a desired rate (e.g., slowly). This approach may be particularly useful where it is desirable to react any unreacted hydrogen containing material which may be passed to the reacted solution receptacle, since the solution receptacle will then contain a portion of the catalyst.

### H. Fluid Movers

Various pumps or other such active components may be used to move fluid through the hydrogen generators and components thereof which are described herein. These include, for example, osmotic pumps, hydrogen pumps, piezoelectric pumps, bubble jets, and electrochemical pumps.

Electrochemical pumps may be especially suitable for applications in which the device will require a long shelf life. Such pumps utilize the electrolysis of a small amount of fluid (e.g., water) to generate hydrogen for the pump, and an oxygen getter to absorb the oxygen generated by the electrolysis reaction (thereby preventing it from recombining with the hydrogen). The hydrogen so generated initializes the hydrogen pump working fluid.

Various electrolyzer/bubble jet hybrids may also be used in the devices described herein. In such embodiments, the electrolyzer may be utilized as a heat source, which may reduce or avoid the need for a separate heating element to heat the reactor, catalyst or fluid.

Various passive devices may also be used to move fluid through the hydrogen generators and components thereof which are described herein. Thus, in some embodiments, various types of spring driven piston-type pumps may be utilized at various points in the flow path. In other embodiments, elastomeric receptacles may be used to contain the fluid which dissolves the hydrogen-containing material, and which undergo self-deflation to maintain the fluid under pressure. In some variations of this embodiment, one or more springs or elastic bands may be applied to the exterior of a bag or other receptacle to achieve a similar effect.

In other embodiments, pressure may be applied to the fluid receptacle by way of one or more spring driven plates. Thus, in one such embodiment, the receptacle may be in the form of a plastic bag which is maintained between one or more plates and/or another surface, and the plates or surfaces may be pressed or pulled together by means of one or more flat-leafed springs, elastomeric bands, or other such devices.

In still other embodiments, the pressure within the fluid reservoir (element 132 in the embodiment of FIGS. 8-10) may be manipulated to apply compressive force to the fluid receptacle. This may be accomplished, for example, by maintaining the fluid reservoir at a positive pressure, as through the addition of a suitable gas or volatile liquid. Such gasses or volatile liquids include, without limitation, butane, propane, and various halogenated hydrocarbons (including fluorocarbons, chlorofluorocarbons, and halogenated ethers). In variations of this embodiment, the gas or volatile liquid may instead be utilized to drive a piston which exerts compressive force against the fluid receptacle.

In further embodiments, a partial vacuum may be formed in or about the reacted solution receptacle to pull fluid from the fluid receptacle and through the reactor. This may be accomplished, for example, through the use of one or more extension springs.

### I. Housing Materials

Various materials may be used in the housings of the hydrogen generators described herein. Preferably, the housing comprises aluminum, due to the unique combination of strength, light weight, and relative chemical inertness. However, it will be appreciated that the housing could also be constructed from various other materials, including various metals (such as magnesium, tin, titanium, and their alloys) and various metal alloys, including steel. The housing may also comprise various polymeric materials, including polyethylene, polypropylene, PVC, nylon, graphite, and various glasses. If the housing comprises a metal such as aluminum, the interior of the housing is preferably coated with a protective layer of a suitable material, such as an epoxy resin, which is inert to the reactants and the products and byproducts of the hydrolysis reaction. The housing, or portions thereof, may also be thermally insulated.

### J. Hydrides, Borohydrides and Boranes

Various hydrides, or combinations of hydrides, that produce hydrogen upon contacting water at temperatures that are desired within the hydrogen generator may be used in the devices and methodologies described herein. Salt-like and covalent hydrides of light metals, especially those metals found in Groups I and II, and even some metals found in Group III, of the Periodic Table are useful and include, for example, hydrides of lithium, sodium, potassium, rubidium, cesium, magnesium, beryllium, calcium, aluminum or combinations thereof. Preferred hydrides include, for example, borohydrides, alanates, or combinations thereof.

As shown in TABLE 1 and TABLE 2 below, the hydrides of many of the light metals appearing in the first, second and third groups of the periodic table contain a significant amount of hydrogen on a weight percent basis and release their hydrogen by a hydrolysis reaction upon the addition of water. The hydrolysis reactions that proceed to an oxide and hydrogen (see TABLE 2) provide the highest hydrogen yield, but may not be useful for generating hydrogen in a lightweight hydrogen generator that operates at ambient conditions because these reactions tend to proceed only at high temperatures. Therefore, the most useful reactions for a lightweight hydrogen generator that operates at ambient conditions are those reactions that proceed to hydrogen and a hydroxide. Both the salt-like hydrides and the covalent hydrides are useful compounds for hydrogen production because both proceed to yield the hydroxide and hydrogen.

TABLE 1
Hydrogen Content of Metal Hydrides

| | Wt % H₂ | | |
|---|---|---|---|
| | | With | Double |
| | | Stoichiometric | Stoichiometric |
| Compound | Neat | H₂O | H₂O |
| Salt-like Hydrides | | | |
| LiH | 12.68 | 11.89 | 7.76 |
| NaH | 4.20 | 6.11 | 4.80 |
| KH | 2.51 | 4.10 | 3.47 |
| RbH | 1.17 | 2.11 | 1.93 |
| CsH | 0.75 | 1.41 | 1.33 |
| MgH₂ | 7.66 | 9.09 | 6.47 |
| CaH₂ | 4.79 | 6.71 | 5.16 |
| Covalent Hydrides | | | |
| LiBH₄ | 18.51 | 13.95 | 8.59 |
| Na BH₄ | 10.66 | 10.92 | 7.34 |
| K BH₄ | 7.47 | 8.96 | 6.40 |
| Mg (BH₄)₂ | 11.94 | 12.79 | 8.14 |
| Ca (BH₄)₂ | 11.56 | 11.37 | 7.54 |
| LiAlH₄ | 10.62 | 10.90 | 7.33 |
| NaAlH₄ | 7.47 | 8.96 | 6.40 |
| KAlH₄ | 5.75 | 7.60 | 5.67 |
| Li₃AlH₆ | 11.23 | 11.21 | 7.47 |
| Na₃AlH₆ | 5.93 | 7.75 | 5.76 |

TABLE 2
Hydrogen Yield from the Hydrolysis of Metal Hydrides

| | | Hydrogen Yield | |
|---|---|---|---|
| | | (wt %) | |
| | Equation | Stoichiometric | Double |
| Reaction | No. | Water | Water |
| Reaction to Oxide | | | |
| LiBH₄ + 2 H₂O → LiBO₂ + 4 H₂ | 1 | 13.95 | 8.59 |
| 2 LiH + H₂O → Li₂O + 2 H₂ | 2 | 11.89 | 7.76 |
| NaBH₄ + 2 H₂O → NaBO₂ + 4 H₂ | 3 | 10.92 | 7.34 |
| LiAlH₄ + 2 H₂O → LiAlO₂ + 4 H₂ | 4 | 10.90 | 7.33 |
| Reaction to Hydroxide | | | |
| LiBH₄ + 4 H₂O → LiB(OH)₄ + 4 H₂ | 5 | 8.59 | 4.86 |
| LiH + H₂O → LiOH + H₂ | 6 | 7.76 | 4.58 |
| NaBH₄ + 4 H₂O → NaB(OH)₄ + 4 H₂ | 7 | 7.34 | 4.43 |
| LiAlH₄ + 4 H₂O → LiAl(OH)₄ + 4 H₂ | 8 | 7.33 | 4.43 |
| Reaction to Hydrate Complex | | | |
| LiH + 2 H₂O → LiOH•H₂O + H₂ | 9 | 4.58 | 2.52 |
| 2 LiAlH₄ + 10 H₂O → LiAl₂(OH)₇•H₂O + LiOH•H₂O + 8 H₂ | 10 | 6.30 | 3.70 |
| NaBH₄ + 6 H₂O → NaBO₂•4 H₂O + 4 H₂ | 11 | 5.49 | 3.15 |

The salt-like hydrides, such as LiH, NaH, and MgH₂, are generally not soluble in most common solvents under near ambient conditions. Many of these compounds are only stable as solids, and decompose when heated, rather than melting congruently. These compounds tend to react spontaneously with water to produce hydrogen, and continue to react as long as there is contact between the water and the salt-like hydride. In some cases the reaction products may form a blocking layer that slows or stops the reaction, but breaking up or dispersing the blocking layer or removing it from the reaction zone immediately returns the reaction to its initial rate as the water can again contact the unreacted hydride. Methods for controlling the hydrogen production from the salt-like compounds generally include controlling the rate of water addition.

The covalent hydrides shown in TABLE 1 are comprised of a covalently bonded hydride anion, e.g., BH₄⁻, AlH₄⁻, and a simple cation, e.g., Na⁺, Li⁺. These compounds are frequently soluble in high dielectric solvents, although some decomposition may occur. For example, NaBH₄ promptly reacts with water at neutral or acidic pH but is kinetically quite slow at alkaline pH. When NaBH₄ is added to neutral pH water, the reaction proceeds but, because the product is alkaline, the reaction slows to a near stop as the pH of the water rises and a metastable solution is formed. In fact, a basic solution of NaBH₄ is stable for months at temperatures below 5° C.

Some of the covalent hydrides, such as LiAlH₄, react very similarly to the salt-like hydrides and react with water in a hydrolysis reaction as long as water remains in contact with the hydrides. Other covalent hydrides react similarly to NaBH₄ and KBH₄ and only react with water to a limited extent, forming metastable solutions. However, in the presence of catalysts, these metastable solutions continue to react and generate hydrogen.

Using a catalyst to drive the hydrolysis reaction of the covalent hydrides to completion is advantageous because the weight percent of hydrogen available in the covalent hydrides is generally higher than that available in the salt-like hydrides, as shown in TABLE 1. Therefore, the covalent hydrides are preferred as a hydrogen source in some embodiments of a hydrogen generator because of their higher hydrogen content as a weight percent of the total mass of the generator.

The devices and methodologies described herein may use solid chemical hydrides as the hydrogen-containing material which is combined with water in a manner that facilitates a hydrolysis reaction to generate hydrogen gas. Preferably, these chemical hydrides include alkali metal borohydrides, alkali metal hydrides, metal borohydrides, and metal hydrides, including, but not limited to, sodium borohydride NaBH₄ (sometimes designated NBH), sodium hydride (NaH), lithium borohydride (LiBH₄), lithium hydride (LiH), calcium hydride (CaH₂), calcium borohydride (Ca(BH₄)₂), magnesium borohydride (MgBH₄), potassium borohydride (KBH₄), and aluminum borohydride (Al(BH₄)₃).

Another class of materials that may be useful in the devices and methodologies described herein are chemical hydrides with empirical formula BₓNₓH_{y} and various compounds of the general formula BₓN_{y}H_{z}. Specific examples of these materials include aminoboranes such as ammonia borane (H₃BNH₃), diborane diammoniate, H₂B(NH₃)₂BH₄, poly-(aminoborane), borazine (B₃N₃H₆), morpholine borane, borane-tetrahydrofuran complex, diborane, and the like. In some applications, hydrazine and its derivatives may also be useful, especially in applications where the toxicity of many hydrazine compounds is trumped by other considerations.

Various hydrogen gas-generating formulations may be prepared using these or other aminoboranes (or their derivatives). In some cases, the aminoboranes may be mixed and ball milled together with a reactive heat-generating compound, such as LiAlH₄, or with a mixture, such as NaBH₄ and Fe₂O₃. Upon ignition, the heat-generating compound in the mixture undergoes an exothermic reaction, and the energy released by this reaction pyrolyzes the aminoborane(s), thus forming boron nitride (BN) and H₂ gas. A heating wire, comprising nichrome or other suitable materials, may be used to initiate a self-sustaining reaction within these compositions.

In some embodiments of the devices and methodologies described herein, salt hydrates may be utilized as the water-generating material. The use of such materials can be advantageous in some applications due in part to the large amounts of thermal energy per unit weight that can be consumed by the dehydration reaction of these materials. Materials other than hydrate salts may be used in place of, or in addition to, these materials in the various devices and methodologies disclosed herein. For example, materials that undergo condensation reactions (especially dehydration condensation reactions), either by themselves or by reacting with other materials, may be used. One example of such a material includes materials that undergo condensation polymerization reactions. Another example of such a material are materials that undergo dehydration reactions, either through intramolecular or intermolecular processes. For example, carboxylic acids and polycarboxylic acids that undergo dehydration reactions to form the corresponding ester, ether, or acetate, either through an intermolecular reaction or through an intramolecular reaction, may be utilized in some embodiments as the water-generating material. A further advantage of this type of material is that the dehydration product may contain no hydration states, or fewer hydration states, than the starting material, thus increasing the total amount of water liberated by the reaction.

A further class of materials that may be used in this capacity include sterically hindered hydrates that exhibit rotational isomerism. These materials are capable of undergoing rotation about the axis of a central bond (this will frequently be a boron carbon bond, a nitrogen-nitrogen bond, or a carbon-carbon bond, but may occur around other bonds as well) to transition between at least a first and second isomeric state. The material is provided in a first state in which it is an n-hydrate material at temperature T₁. However, upon exposure to heat, it undergoes a dehydration reaction, and also undergoes rotation about the bond to transition to a second isomeric state in which it is a k-hydrate material at T₁, wherein n>k. This may be, for example, because of a change in symmetry of the second state compared to the first state, or because of the presence of hydrogen bonding or other phenomenon which interfere with the ability of water molecules to bind to the material (hydrogen bonding and other such phenomenon may also be utilized advantageously to keep the material in the second isomeric state after rotation about the axis has occurred). As a result of this reaction, the hydrate loses water irreversibly or semi-irreversibly.

A similar phenomenon may be used with the hydrogen-generating material itself. That is, the hydrogen-generating material may be designed so that, when it undergoes the hydrogen evolution reaction, the heat evolved causes the resulting byproduct to assume (preferably irreversibly) a second rotational isomeric state in which it binds to a reduced amount of water, as compared to the rotational isomers of the byproduct. The heat adsorbed by the change in isomeric states may serve as a further aid in controlling the overall heat generated by the hydrogen generator. In some embodiments, rotational isomers may be used as a heat adsorbing means, even without respect to their possible hydration states.

In some embodiments of the devices, methodologies and compositions described herein, steric hindrance can be utilized as a mechanism to prevent the hydrogen-generating material from undergoing a hydration reaction, as, for example, by occluding binding sites for water molecules in the reaction byproduct. In these embodiments, various substituted hydrides, borohydrides, boranes, aminoboranes, hydrazines, and the like may be utilized as the sterically hindered reactant, with the choice of substituents depending in part on the stereochemistry of the system. These materials offer the potential advantage of consuming most, if not all, of the water present in the system in the hydrogen-generation reaction, whether that water is present as free water molecules or water of crystallization.

Still another class of materials useful as a source of stored moisture are polymer hydrates. These compounds include (but are not limited to) polycarboxylic acids, polyacrylamides, and other polymeric materials with functional groups capable of binding to water. Both classes of compounds can act to solidify, or gel, large quantities of water. Unlike inorganic hydrates, these materials lack both a crystalline structure (i.e., they are amorphous) and a sharp melting or dehydration temperature. Both give up their water over a broad temperature range. The use of compounds such as these in a reactor of the type described above can produce a gradual release of water. In some embodiments, the rate of release may increase with any increase in temperature.

Some of these compounds, notably polyacrylimides, have another useful feature, namely, that their affinity for water tends to vary inversely with the ionic strength of the solution they are in contact with. This means that a saturated polymer in contact with a dilute ionic solution will release water into the solution as its ion concentration increases. If a solid hydride is brought into contact with a polymer saturated with respect to pure water, the increase in ionic concentration in the solution brought about by the hydrolysis reaction will cause the polymer to release additional water.

### K. Catalysts

As noted above, in some instances, a catalyst may be required to initiate the hydrolysis reaction of the chemical hydride with water. Useful catalysts for this purpose include one or more of the transition metals found in Groups IB-VIII of the Periodic Table. The catalyst may comprise one or more of the precious metals and/or may include cobalt, nickel, tungsten carbide or combinations thereof. Ruthenium, ruthenium chloride and combinations thereof are preferred catalysts.

Various organic pigments may also be useful in catalyzing the hydrolysis reaction. Some non-limiting examples of these materials include pyranthrenedione, indanthrene Gold Orange, ditridecyl-3,4,9,10-perylenetetracarboxylic diimide, indanthrene black, dimethoxy violanthrone, quinacridone, 1,4-di-keto-pyrrolo (3,4 C) pyrrole, indanthrene yellow, copper phthalocyanine, 3,4,9,10, perylenetetracarboxylic dianhydride, isoviolanthrone, perylenetetracarboxylic diimide, and perylene diimide. These materials, most of which are not metal based, may offer environmental or cost advantages in certain applications.

The catalysts used in the devices and methodologies disclosed herein may be present as powders, blacks, salts of the active metal, oxides, mixed oxides, organometallic compounds, or combinations of the foregoing. For those catalysts that are active metals, oxides, mixed oxides or combinations thereof, the hydrogen generator may further comprise a support for supporting the catalyst on a surface thereof. In one preferred embodiment, the support comprises an Al/Sr stabilizer disposed on a ceramic matrix material.

The catalyst can be incorporated into the hydrolysis reaction in a variety of ways, including, but not limited to: (i) mixing the catalyst with the hydrogen-containing material first, and then adding water to the hydrogen-containing material/catalyst mixture; (ii) mixing the catalyst with the reactant water first, and then adding this solution/mixture to the hydrogen-containing material; or (iii) combining the hydrogen-containing material with water in the presence of a porous structure that is made of, or contains, a catalyst. The hydrogen generating devices described herein can be adapted to support one or more of these methods for incorporating catalyst into a reactor.

Catalyst concentrations in the hydrogen-generating compositions described herein may vary widely. For some applications, the set catalyst concentration may range between about 0.1 wt % to about 20 wt % active metals based on the total amount of hydride and on the active element or elements in the catalyst. Preferably, the set catalyst concentration may range from between about 0.1 wt % to about 15 wt %, and more preferably, between about 0.3 wt % to about 7 wt %.

### L. Reaction Interface

Various materials may be used in the reaction interface in the hydrogen generators described herein. Preferably, the reaction interface is sufficiently porous to permit the egress of spent hydrogen-containing material (e.g., sodium borate and its hydrates) through the interface, but has sufficient strength to withstand the pressure exerted on it by the compression mechanism within the dispenser. The reaction interface also preferably exhibits sufficient wicking action so that water applied to it will be evenly distributed across its surface.

In some embodiments, this interface may contain multiple components. For example, the interface may contain a first layer of a porous material, such as screening or plastic or wire mesh or foam, and a second layer of a porous wicking agent. In other embodiments, these elements may be combined (for example, a suitable wicking agent may be deposited on the surfaces of a wire or plastic mesh or foam, or the mesh itself may have wicking characteristics). Specific, non-limiting examples of foams that may be used in the reaction interface include aluminum, nickel, copper, titanium, silver, stainless steel, and carbon foams. The surface of the foam may be treated to increase a hydrophilic nature of the surface. Cellular concrete may also be used in the reaction interface.

The temperature of the reaction interface is an important consideration in many of the embodiments of the devices and methodologies disclosed herein, and hence, various heating elements and temperature monitoring or temperature control devices may be utilized to maintain the reaction interface at a desired temperature. For example, when sodium borohydride is utilized as the hydrogen-containing material, the sodium borate reaction byproduct can exist in various hydration states, and the population of each of these states is a function of temperature. Thus, at 40° C., the tetrahydrate species is the principal reaction product, while at 60° C., the dihydrate species is the principal reaction product, and at 100° C., the monohydrate species is the principal reaction product. From a weight penalty standpoint, it is preferable that the reaction interface be maintained at a temperature that will favor the formation of anhydrous or lower hydrate species, since this will require less water to evolve a given volume of hydrogen gas. Moreover, the resulting system will, in many cases, be less prone to the condensation issues described herein, even if no desiccant is employed in the hydrogen gas stream.

The use of chelating agents for the reaction byproducts may also be useful in the devices and methodologies described herein. For example, when sodium borohydride is used as the hydrogen-containing material, a chelating agent may be added to the sodium borohydride, or to the water or other liquid it is reacted with. Such a material binds the sodium borate reaction byproduct and, by occupying ligand sites, prevents or minimizes the formation of hydrates, especially higher order hydrates. Hence, chelating agents may be advantageously used in some instances to reduce the weight penalty associated with the system. Chelating agents, surfactants and other such materials may also be used in the devices and methodologies described herein as solubility enhancing agents.

### M. Control Devices

As previously noted, the hydrogen generators described herein include an inlet into the reaction chamber for the introduction of fluid therein, and an outlet from the reaction chamber for the evolved hydrogen and reaction byproducts to exit the generator. Both the inlet and the outlet of the reaction chamber may comprise various fluid control devices such as, for example, check valves, ball valves, gate valves, globe valves, needle valves, pumps, or combinations thereof. These control devices may further comprise one or more pneumatic or electric actuators and the hydrogen generator may further include a controller in electric or pneumatic communication with one or more of these actuators for controlling the open or closed position of the fluid control devices. Suitable circuitry, chips, and/or displays may also be provided for control purposes.

It will further be appreciated that various types of thermistors and piezoelectric devices may be utilized in the hydrogen generators described herein, both to control the manner and conditions under which reactants are exposed to catalyst, and to control the overall flow of fluids and gases through the hydrogen generator. In some embodiments, these elements and/or the hydrogen generator as a whole may be fabricated as MEMS devices using fabrication techniques that are well known to the semiconductor arts.

### N. Antifoaming Agents

In some embodiments of the devices and methodologies disclosed herein, an antifoaming agent is added to the water that is introduced into the reaction chamber. The use of an antifoaming agent may be advantageous in some applications or embodiments, since the generation of hydrogen during the hydration reaction frequently causes foaming. Hence, by adding an antifoaming agent to the reactant water, the size and weight of the hydrogen generator can be minimized, since less volume is required for disengagement of the gas from the liquid/solids. Polyglycol anti-foaming agents offer efficient distribution in aqueous systems and are tolerant of the alkaline pH conditions found in hydrolyzing borohydride solutions. Other antifoam agents may include surfactants, glycols, polyols and other agents known to those having ordinary skill in the art.

### O. pH Adjusting Agents

Various pH adjusting agents may be used in the devices and methodologies disclosed herein. The use of these agents is advantageous in that the hydration reaction typically proceeds at a faster rate at lower pHs. Hence, the addition of a suitable acid to the fluid mix entering the reaction chamber, as by premixing the acid into the reactant water, may accelerate the evolution of hydrogen gas. Indeed, in some cases, the use of a suitable acid eliminates the need for a catalyst.

Some non-limiting examples of acids that may be suitable for this purpose include, for example, boric acid, mineral acids, carboxylic acids, sulfonic acids and phosphoric acids. The use of boric acid is particularly desirable in some applications, since it aids recycling by avoiding the addition to the reaction byproduct mixture of additional heteroatoms, as would be the case, for example, with sulfuric acid or phosphoric acid. Moreover, boric acid is a solid and can be readily mixed with the hydrogen-containing material if desired; by contrast, other pH adjusting agents must be added to the aqueous solution or other material being reacted with the hydrogen-containing material.

In some embodiments, cation exchange resin materials may also be used as pH adjusting agents. These materials may be added to the hydrogen-containing material in acid form and as high surface area powders.

In other embodiments, carboxylic acids and the like may be used as the pH adjusting agent. These materials may be advantageous in certain applications because they frequently exist in various hydration states, and hence provide additional water to the system. Moreover, some carboxylic acids are capable of undergoing condensation reactions, with the addition of heat, to evolve water. Hence, these materials can aid both with thermal control and by contributing water to the system.

While it may be desirable in some applications of the systems and methodologies disclosed herein to utilize a pH adjusting agent to lower the pH of a hydrogen-generating composition or of a liquid medium that is to be reacted with it, in other applications, the use of a pH adjusting agent may be utilized to increase the pH of the hydrogen-generating composition or the liquid medium with which it reacts. For example, while many hydrogen-generating compositions achieve a higher rate of hydrogen evolution at lower pHs, and while this is desirable in some situations, in other situations, as when it is necessary to transport the hydrogen-generating composition, a high rate of hydrogen evolution may be disadvantageous. In these situations, a pH adjusting agent may be utilized to render the composition more alkaline upon exposure of the material to water or moisture, hence making the composition less reactive and safer to handle.

Some non-limiting examples of alkaline pH adjusting agents include, without limitation, various metal hydroxides, including lithium hydroxide, sodium hydroxide, potassium hydroxide, RbOH, CsOH, ammonium hydroxide, N(CH₃)₄OH, NR₄OH, NR^{a}ₓR^{b}₍₄₋ₓ₎OH, and NR^{a}R^{b}R^{c}R^{d}OH compounds, wherein R^{a}, R^{b}, R^{c} and R^{d} can each independently be hydrogen, alkyl, or aryl groups; various metal oxides, such as Li₂O, Na₂O, K₂O, Rb₂O, Cs₂O; various organic and metal amines; and the like.

### P. Delayed Release Compositions

Various delayed-release compositions may be utilized in the hydrogen-generating materials described herein. Such materials, which may be utilized, for example, to control the reactivity of the hydrogen-generating materials, include, without limitation, slow-release coatings, micro-encapsulations, and/or slowly-dissolving polymer carriers. For example, in some applications, it may be desirable to render the hydrogen-generating composition initially unreactive to water or moisture so that the composition will be safer for handling and transportation. In one particular type of embodiment, this may be accomplished by providing the composition in the form of pellets, granules, or other discrete units whose surfaces are coated with one or more layers of a material or materials that prevent, delay or control the reaction of the composition with moisture, water, or one or more liquid reactants.

One particular example of a delayed release composition that may be used with the hydrogen generating compositions described herein is ethyl cellulose. This material is an excellent film-forming material with strong adhesion that is insoluble in water and that can be used to create a moisture-impermeable barrier over the surfaces of a hydrogen-generating material. It may be used in conjunction with plasticizers such as phthalates, phosphates, glycerides, and esters of higher fatty acids and amides to create films of sufficient flexibility. Ethyl cellulose may be used alone or in combination with water soluble materials such as methyl cellulose as a barrier to delay the reaction of hydrogen-generating materials with water or with other liquid reactions or solutions. Ethyl cellulose coatings may be applied by spray coating or from solutions of appropriate solvents such as cyclohexane.

In some embodiments, ethyl cellulose based films or other suitable materials may be used to form a protective film over hydrogen-generating materials that render these materials safer for shipping and handling. At the point of use, the coated hydrogen-generating material may then be reacted with water or with other liquid reactants or solutions in a controlled or time delayed manner.

In some embodiments, this reaction may be facilitated through the addition of suitable amounts of appropriate solvents and/or surfactants to the liquid reactants or solutions that facilitate the removal of the coating. In the case of ethyl cellulose, for example, if the hydrogen-generating material is being reacted with water or an aqueous solution, suitable amounts of such solvents as ethanol, methanol, acetone, chloroform, ethyl lactate, methyl salicylate, toluene, methylene chloride, or various mixtures of the foregoing may be added to the water or aqueous solution to facilitate the removal of, or the generation of openings in, the coating, thereby allowing the hydrogen-generating material to react. The concentration of these solvents may be manipulated to achieve a desired rate of reaction or to permit the onset of the reaction in a desired time frame.

Alternatively or in combination with the foregoing approach, the coating may be formulated with a sufficient amount of a water soluble material such as methyl cellulose to permit the hydrogen-generating material to react at a desired rate, or in a desired timeframe, upon exposure to water or to the aqueous solution. It will be appreciated that wide variations of release rates or release patterns can be achieved by varying polymer ratios and coating weights.

In other embodiments, a protective coating or coatings may be applied to pellets, granules, or particles of a hydrogen-generating material to render the material safer for handling and transportation. At the point of use, this coating or coatings may then be stripped with a suitable solvent prior to use of the hydrogen-generating material. Since the total amount of coating applied to the hydrogen-generating material may be quite small, and since the complete removal of this coating from the surfaces of the hydrogen-generating material may not be necessary to render the material suitably reactive to water or to other reagents, in many instances the amount of solvent required to render the material suitably reactive may be quite small.

In still other embodiments, coating removal may be achieved at the point of use through mechanical or physical means. For example, the coated particles of the hydrogen generating material may be subjected to mechanical stress so as to rupture the coating, thereby exposing a portion of the underlying hydrogen-generating material for reaction (in such embodiments, the coating may be made sufficiently brittle so that it is frangible). This can be achieved, for example, by grinding or abrading the particles, subjecting the particles to pressure or sound waves, heating the particles (e.g., so as to induce thermal stress in the coating or to melt or soften the coating), irradiating the particles, or the like.

In some embodiments, the hydrogen-generating composition may be mixed with water-generating materials of the type described herein, and the aforementioned mechanical or physical means may be utilized to induce the evolution of water from the water-generating material. The resulting evolution of hydrogen gas may then rupture or cause perforations or disruptions in the coating, thereby exposing a portion of the hydrogen-generating material for further reaction.

In one specific embodiment, a container of the hydrogen-containing material may be provided which is equipped with a pull tab. When the tab is pulled, the associated mechanical action causes the coating on a portion of the particles to be stripped or ruptured, thereby rendering this portion of the particles available for immediate reaction with water or another suitable liquid medium. The remaining particles can be engineered with a timed release profile that is suitable for the particular application.

In other embodiments, the hydrogen-generating composition may be provided with, or interspersed with, conductive filaments or another suitably conductive medium that can generate localized heating of the particles through ohmic resistance. At the point of use, a suitable electric current can be passed through the conductive medium to melt or rupture a portion of the coating on some of the particles. In such embodiments, the coating may comprise a material such as a hydrocarbon wax that has a suitably low melting or softening temperature.

In further embodiments, multiple coatings schemes or compositions may be utilized to produce a plurality of species of coated hydrogen-generating materials that have different reaction rates, or that react in different timeframes, with respect to a given liquid reagent. For example, in one possible embodiment, a plurality of particles species M₁, . . . , Mₙ, wherein n>2, may be created that have respective coatings Cₗ, . . . , Cₙ, wherein, for i=1 to n, coating Cᵢ allows a percentage pᵢ of the hydrogen generating material in particle species Mᵢ to react with water or another liquid reagent within tᵢ minutes. The species M₁, . . . , Mₙ may then be mixed in various relative proportions, concentrations or weight percentages such that the resulting mixture has a desired hydrogen generation profile as a function of time.

As noted above, in some embodiments, multiple coatings may be utilized that have different chemical or physical properties. For example, in some embodiments, a modified release coating may be used as an external coating, and a stabilizing coating may be used as an interior coating. In such embodiments, the stabilising coat may act as a physical barrier between the hydrogen-generating material and the modified release coating.

For example, the stabilizing coat may act to slow migration of moisture or solvent between the modified release coating and the hydrogen-generating material. While the stabilizing coat will preferably keep the hydrogen-generating material separated from the modified release coating during storage, the stabilizing coating will preferably not interfere significantly with the rate of release or reaction of the hydrogen-generating material, and therefore may be semi-permeable or even soluble in water or in the liquid medium that the hydrogen-generating material is to be reacted with. Hence, the stabilizing coat may be utilized to keep migration of hydrogen-generating materials to a minimum such that their interaction with coating materials is reduced or prevented, while still allowing for release of hydrogen-generating materials in an aqueous environment.

The stabilizing coat may be any suitable material which creates an inert barrier between the hydrogen-generating material and the modified release coating, and may be water soluble, water swellable or water permeable polymeric or monomeric materials. Examples of such materials include, but are not limited to, hydroxypropylmethyl cellulose, hydroxypropyl cellulose, polyvinyl pyrrolidone, polyethylene glycol or methacrylate based polymers. Preferably the stabilising coat includes a water-soluble polymer that does not interfere with the release of the hydrogen-generating material.

The modified release coating may also be any suitable coating material, or combination of coating materials, that will provide the desired modified release profile. For example, coatings such as enteric coatings, semi-enteric coatings, delayed release coatings or pulsed release coatings may be desired. In particular, coatings may be utilized that provide an appropriate lag in release prior to the rapid release at a rate essentially equivalent to immediate release of the hydrogen-containing material.

In particular, materials such as hydroxypropylmethyl cellulose phthalate of varying grades, methacrylate based polymers and hydroxypropylmethyl cellulose acetate succinate may be utilized in various applications. It is also possible to use a mixture of enteric polymers to produce the modified release coating, or to use a mixture of enteric polymer with a water permeable, water swellable or water-soluble material. Suitable water-soluble or water permeable materials include but are not limited to hydroxypropylmethyl cellulose, hydroxypropyl cellulose, polyvinyl pyrrolidone, polyethylene glycol or mixtures thereof.

Another class of delayed release coatings that may be utilized in some embodiments of the compositions, systems and methodologies described herein are basic materials, such as metal hydroxides or metal or organic amines, including the materials described herein as pH adjusting agents. In the case of hydrogen-generating materials that react with water or aqueous solutions, coatings of these materials on the exterior surfaces of the hydrogen-generating materials can be used to render the hydrogen-generating material essentially unreactive (or reactive at a very slow rate) to moisture or to relatively small amounts of water by rendering the effective pH at the reaction interface (e.g., at the surface of the hydrogen-generating material) sufficiently alkaline. On the other hand, if the amount of coating material is sufficiently small, at the point of use, the amount of water or liquid medium that the hydrogen-generating material is exposed to may be sufficiently large to solvate the alkaline material without significantly affecting the pH of the resulting solution. So long as the coating is selected such that solvation occurs fast enough, the presence of such a coating can be made to have little or no effect on the reactivity of the particles of the hydrogen-generating material at the point of use.

### Q. Wicking Agents

As previously noted, the hydrolysis reaction of a hydride cannot proceed if water is unable to reach the hydride. When pellets of some hydrides, such as LiH, react with water, a layer of insoluble reaction products is formed that blocks further contact of the water with the hydride. The blockage can slow down or stop the reaction.

The devices and methodologies disclosed herein overcome this problem by providing a means for expelling such insoluble products from the reaction zone. However, in some cases, the addition of a wicking agent within the pellets or granules of the hydride or borohydride improves the water distribution through the pellet or granule and ensures that the hydration reaction quickly proceeds to completion. Both salt-like hydrides and covalent hydrides benefit from an effective dispersion of water throughout the hydride. Useful wicking materials include, for example, cellulose fibers like paper and cotton, modified polyester materials having a surface treatment to enhance water transport along the surface without absorption into the fiber, and polyacrylamide, the active component of disposable diapers. The wicking agents may be added to the hydrogen-containing material in any effective amount, preferably in amounts between about 0.5 wt % and about 15 wt % and most preferably, between about 1 wt % and about 2 wt %. It should be noted, however, that, in some applications, variations in the quantity of wicking material added to the hydrogen-containing material do not seem to be significant; i.e., a small amount of wicking material is essentially as effective as a large amount of wicking material.

In some embodiments, one or more wicking agents may be used to create a conduit in which at least a portion of the excess water which may be present in the hydrogen generation reaction byproducts may be returned to another part of the hydrogen generator so that it may be further utilized in the generation of hydrogen gas. Such wicking agents may be disposed, for example, downstream from the catalytic reactor, and may be in fluidic contact with a water reservoir or with the catalytic reactor itself.

### R. Liquid Reactants

While the devices and methodologies described herein have frequently been explained in reference to the use of water as a reactant with the hydride, borohydride, borane, or other hydrogen-containing material, it will be appreciated that various other materials may be used in place of, or in addition to, water. For example, various alcohols may be reacted with the hydrogen-containing material. Of these, low molecular weight alcohols, such as methanol, ethanol, normal and iso-propanol, normal, iso- and secondary-butanol, ethylene glycol, propylene glycol, butylene glycol, and mixtures thereof, are especially preferred. The alcohols may be used either alone or as aqueous solutions of varying concentrations. Liquid reactants containing alcohol may be particularly useful in low temperature applications where the liquid reactant may be subjected to freezing. Various liquid reactants containing ammonia or other hydrogen-containing materials may also be used.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

1. A hydrogen generator, comprising:
a reaction chamber equipped with a tortuous passageway for the flow of reactants therethrough, said passageway containing a catalyst disposed on a surface thereof,
a fluid; and
a hydrogen-containing material which reacts with said fluid in the presence of said catalyst to generate hydrogen gas.

2. The hydrogen generator of claim 1, wherein said fluid is a fluidic medium, and wherein said hydrogen-containing material is disposed in said fluidic medium.

3. The hydrogen generator of claim 1, wherein said tortuous channel is formed by the cells of an open-celled foam.

4. The hydrogen generator of claim 3, wherein said foam is a metal foam.

5. The hydrogen generator of claim 4, wherein said foam is a nickel foam having a cobalt boride catalyst disposed on a surface thereof.

6. The hydrogen generator of claim 5, wherein said hydrogen-containing material is sodium borohydride.

7. The hydrogen generator of claim 3, wherein the catalyzed foam has an average cell diameter within the range of about 85 μm to about 1700 μm.

8. (canceled)

9. The hydrogen generator of claim 3, wherein the catalyzed foam has an average cell diameter within the range of about 200 μm to about 500 μm.

10-11. (canceled)

12. The hydrogen generator of claim 3, wherein the catalyzed foam is produced by depositing a catalyst on an uncatalyzed foam.

13. The hydrogen generator of claim 12, wherein said uncatalyzed foam has a surface area within the range of about 10 μm to about 120 cm²/cm³.

14. (canceled)

15. The hydrogen generator of claim 12, wherein said uncatalyzed foam has a surface area within the range of about 30 μm to about 70 cm²/cm³.

16. (canceled)

17. The hydrogen generator of claim 12, wherein said catalyzed foam has a surface area at least about 10 times greater than the uncatalyzed foam.

18. (canceled)

19. The hydrogen generator of claim 12, wherein said catalyzed foam has a surface area at least about 200 times greater than the uncatalyzed foam.

20-22. (canceled)

23. The hydrogen generator of claim 1, wherein said tortuous channel is a groove on a surface of a substrate.

24. (canceled)

25. The hydrogen generator of claim 23, wherein said groove is serpentine in shape.

26. The hydrogen generator of claim 1, further comprising:
a first receptacle for holding said fluid medium; and
a second receptacle for holding byproducts of the reaction between the fluid and the hydrogen-containing material.

27. The hydrogen generator of claim 26, wherein said first and second receptacles are separated from each other by a common barrier.

28. The hydrogen generator of claim 26, wherein said first receptacle is collapsable.

29. The hydrogen generator of claim 28, wherein said second receptacle has a hydrogen permeable container disposed therein into which the products of the reaction between the fluid and the hydrogen-containing material are received.

30. (canceled)

31. The hydrogen generator of claim 29, wherein said hydrogen permeable container is impermeable to reaction byproducts and the reactants.

32. The hydrogen generator of claim 29, wherein said second receptacle has an inlet and a first outlet, wherein said hydrogen permeable container is in fluidic communication with said inlet, and wherein said first outlet is separated from said inlet by way of said hydrogen permeable container.

33. The hydrogen generator of claim 32, further comprising a second outlet controlled by a pressure activated valve, said second outlet being in fluidic communication with a hydrogen recombiner.

34. The hydrogen generator of claim 33, wherein said pressure activated valve is adapted to assume an open position when the pressure within said second receptacle reaches a predetermined level.

35. The hydrogen generator of claim 33, wherein said second outlet is separated from said inlet by way of said hydrogen permeable container.

36. The hydrogen generator of claim 26, further comprising a third receptacle for holding said hydrogen-containing material, wherein said first, second and third receptacles form a unitary mass.

37. The hydrogen generator of claim 1, wherein said hydrogen-containing material is maintained in pressing engagement with a porous medium, and wherein said fluid is flowed across said porous medium.

38. The hydrogen generator of claim 37, wherein said hydrogen-containing material is a pellet, and wherein said pellet is maintained in pressing engagement with said porous medium by way of a spring.

39. The hydrogen generator of claim 37, wherein said porous medium has an essentially planar surface, and wherein said hydrogen-containing material is maintained in pressing engagement along an axis essentially perpendicular to said essentially planar surface.

40. The hydrogen generator of claim 37, wherein said porous medium is disposed in a chamber having an inlet and an outlet, wherein said fluid enters said chamber through said inlet, and wherein a solution of said hydrogen-containing material in said fluid exits said chamber through said outlet.

41. A hydrogen generator, comprising:
a fluid reservoir containing a fluid;
a first chamber having a hydrogen-containing material disposed therein, said first chamber being adapted to input a flow of said fluid from said fluid reservoir and to output a mixture of said fluid and said hydrogen-containing material;
a reaction chamber containing a catalyst, said reaction chamber being adapted to input said mixture and to react said mixture, in the presence of said catalyst, to evolve hydrogen gas, and being further adapted to output said hydrogen gas and the byproducts of the hydrogen evolution reaction;
a separation chamber, downstream from said reaction chamber, which is adapted to separate the hydrogen gas from the reaction byproducts; and
a valve movable from a first position in which the flow of fluid along a pathway including the fluid reservoir and the first chamber is enabled, to a second position in which the flow of fluid along the pathway is prevented.

42. The hydrogen generator of claim 41, wherein said reaction chamber is equipped with a tortuous passageway for the flow of reactants therethrough, said passageway containing a catalyst disposed on a surface thereof.

43. The hydrogen generator of claim 42, wherein said tortuous channel is formed by the cells of a catalyzed open-celled foam.

44. The hydrogen generator of claim 43, wherein said foam is a metal foam, wherein said foam is a nickel foam having a cobalt boride catalyst disposed on a surface thereof and wherein said hydrogen-containing material is sodium borohydride.

45-49. (canceled)

50. The hydrogen generator of claim 53, wherein the catalyzed foam has an average cell diameter within the range of about 250 μm to about 450 μm.

51-53. (canceled)

54. The hydrogen generator of claim 52, wherein said uncatalyzed foam has a surface area within the range of about 20 μm to about 100 cm²/cm³.

55-57. (canceled)

58. The hydrogen generator of claim 52, wherein said catalyzed foam has a surface area at least about 100 times greater than the uncatalyzed foam.

59-76. (canceled)

77. A hydrogen generator, comprising:
a catalyst;
a fluid;
a hydrogen-containing material;
a mixing chamber adapted to form a mixture of said fluid and said hydrogen-containing material; and
a reaction chamber adapted to react said mixture in the presence of said catalyst to generate hydrogen gas;
wherein the hydrogen generator transitions from a first condition when the pressure of hydrogen gas within the reaction chamber is P₁, to a second condition when the pressure of hydrogen gas within the reaction chamber is P₂, where P₂>P₁; wherein the mixing chamber is adapted to generate said mixture when said hydrogen generator is in said first state; and wherein said mixing chamber is adapted to cease generation of said mixture when said hydrogen generator is in said second state.

78. A hydrogen generator, comprising:
a catalyst;
a fluid;
a hydrogen-containing material; and
a reaction chamber adapted to react a mixture of said fluid and said hydrogen-containing material in the presence of said catalyst to generate hydrogen gas, and being further adapted to separate the generated hydrogen gas from reaction byproducts.
